(19) United States
(12) Patent Application Publication
(10) Pub. No.: US 2026/0155973 A1
(43) Pub. Date: Jun. 4, 2026

(54) SYSTEMS AND METHODS FOR SYNCHRONIZING AUTHENTICATION ATTEMPTS

(71) Applicant: Capital One Services, LLC, McLean, VA (US)

(72) Inventors: Kevin Osborn, McLean, VA (US); Srinivasa Chigurupati, McLean, VA (US); Jeffrey Rule, McLean, VA (US)

(73) Assignee: Capital One Services, LLC, McLean, VA (US)

(21) Appl. No.: 18/968,063

(22) Filed: Dec. 4, 2024

(51) Int. Cl. H04L 9/30; H04W 12/63

(52) U.S. Cl. CPC H04L 9/30; H04W 12/63

(57) ABSTRACT

Systems and methods for synchronizing authentication attempts are provided. A method can include receiving a message from a mobile device when the mobile device authenticates a contactless card via offline data authentication, the message indicating that the mobile device successfully authenticated the contactless card with primary authentication data received from the contactless card. Responsive to the message, the method can also include authenticating the contactless card with secondary authentication data and posting a dummy transaction or a preauthorization in a record of transactions associated with the contactless card to update a stored counter value associated with the contactless card. Interaction between the contactless card and the mobile device during the offline data authentication can increment a counter stored on the contactless card, and updating the stored counter value associated with the contactless card can synchronize the stored counter value with the counter stored on the contactless card.

### BACKGROUND

Contactless card products have become so universally well-known and ubiquitous that they have fundamentally changed the manner in which financial transactions and dealings are viewed and conducted in society today. Contactless card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash. Data security and transaction integrity are of critical importance to businesses facilitating these transactions and to the customers. This need continues to grow as electronic transactions performed with contactless cards constitute an increasingly large share of commercial activity. Accordingly, there is a need to provide businesses and users with an appropriate solution that overcomes current deficiencies to provide data security, authentication, and verification for contactless cards.

As technology continues to develop, contactless cards are used in both online transactions as described above and in offline transactions to confirm an identity of the authorized cardholder. However, use of a contactless card in an offline transaction can adversely impact future use of the contactless card in an online transaction. In particular, some of the technology used to authenticate the contactless card can become out of sync, which may result in deactivation of the contactless card.

In view of the above, there is a need for systems and methods to synchronize authentication attempts when contactless cards are used in connection with offline transactions.

### BRIEF SUMMARY

In some embodiments, a method can include receiving a message from a mobile device when the mobile device authenticates a contactless card via offline data authentication, the message indicating that the mobile device successfully authenticated the contactless card with primary authentication data received from the contactless card, authenticating the contactless card with secondary authentication data, and posting a dummy transaction or a preauthorization in a record of transactions associated with the contactless card to update a stored counter value associated with the contactless card, wherein interaction between the contactless card and the mobile device during the offline data authentication can increment a counter stored on the contactless card, and wherein updating the stored counter value associated with the contactless card can synchronize the stored counter value with the counter stored on the contactless card.

In some embodiments, the primary authentication data can include encrypted data, a public key, or a primary account number of the contactless card.

In some embodiments, the secondary authentication data can include encrypted data, a phone number of the mobile device, or a geolocation of the mobile device.

In some embodiments, the method can include comparing the phone number of the mobile device with a phone number associated with the contactless card and authenticating the contactless card with the secondary authentication information when the phone number of the mobile device matches the phone number of the contactless card.

In some embodiments, the method can include comparing the geolocation of the mobile device with approved geolocations associated with the contactless card and authenticating the contactless card with the secondary authentication information when the geolocation of the mobile device matches or is within a predetermined distance from the approved geolocations associated with the contactless card.

In some embodiments, the method can include instructing a processor to update the stored counter value associated with the contactless card in a database.

In some embodiments, the method can include recording the stored counter value as updated in an authentication cryptogram as a last successful authentication attempt.

In some embodiments, a non-transitory computer-readable medium can include instructions that, when executed by a processor, cause the processor to receive a message from a mobile device when the mobile device authenticates a contactless card via offline data authentication, the message indicating that the mobile device successfully authenticated the contactless card with primary authentication data received from the contactless card, authenticate the contactless card with secondary authentication data, and update a stored counter value associated with the contactless card, wherein interaction between the contactless card and the mobile device during the offline data authentication can increments a counter stored on the contactless card and wherein updating the stored counter value associated with the contactless card can synchronize the stored counter value with the counter stored on the contactless card.

In some embodiments, the primary authentication data can include encrypted data, a public key, or a primary account number of the contactless card.

In some embodiments, the secondary authentication data can include encrypted data, a phone number of the mobile device, or a geolocation of the mobile device.

In some embodiments, the instructions can further cause the processor to post a dummy transaction or a preauthorization in a record of transactions associated with the contactless card to update the stored counter value associated with the contactless card.

In some embodiments, the instructions can further cause the processor to update the stored counter value associated with the contactless card in a database.

In some embodiments, the instructions can further cause the processor to record the stored counter value as updated in an authentication cryptogram as a last successful authentication attempt.

In some embodiments, a server device can include a processor and a memory storing instructions that, when executed by the processor, cause the processor to receive a message from a mobile device when the mobile device authenticates a contactless card via offline data authentication, the message indicating that the mobile device successfully authenticated the contactless card with primary authentication data received from the contactless card, authenticate the contactless card with secondary authentication data, and update a stored counter value associated with the contactless card.

In some embodiments, the primary authentication data can include encrypted data, a public key, or a primary account number of the contactless card.

In some embodiments, the secondary authentication data can include encrypted data, a phone number of the mobile device, or a geolocation of the mobile device.

In some embodiments, interaction between the contactless card and the mobile device during the offline data authentication can increment a counter stored on the contactless card, and updating the stored counter value associated with the contactless card can synchronize the stored counter value with the counter stored on the contactless card.

In some embodiments, the instructions can further cause the processor to post a dummy transaction or a preauthorization in a record of transactions associated with the contactless card to update the stored counter value associated with the contactless card.

In some embodiments, the instructions can further cause the processor to update the stored counter value associated with the contactless card in a database.

In some embodiments, the instructions can further cause the processor to record the stored counter value as updated in an authentication cryptogram as a last successful authentication attempt.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system configured to operate in accordance with one embodiment.

FIG. 2 illustrates an example of a sequence flow in accordance with one embodiment.

FIG. 3A illustrates an example of a sequence flow in accordance with one embodiment.

FIG. 3B illustrates an example of a sequence flow in accordance with one embodiment.

FIG. 3C illustrates an example of a sequence flow in accordance with one embodiment.

FIG. 4 illustrates an example of a message in accordance with one embodiment.

FIG. 5 illustrates an example of a method in accordance with one embodiment.

FIG. 6 illustrates an example of a distributed network authentication system in accordance with one embodiment.

FIG. 7 illustrates an example of a method in accordance with one embodiment.

FIG. 8 illustrates an example of a system in accordance with one embodiment.

FIG. 9 illustrates an example of a contactless card in accordance with one embodiment.

FIG. 10 illustrates an example of a contactless card component in accordance with one embodiment.

FIG. 11 illustrates an example of a sequence flow in accordance with one embodiment.

FIG. 12 illustrates an example of a contactless card in accordance with one embodiment.

FIG. 13 illustrates an example of a mobile device in accordance with one embodiment.

FIG. 14 illustrates an example of a server device in accordance with one embodiment.

FIG. 15 illustrates an example of a system in accordance with one embodiment.

FIG. 16 illustrates an example of a method in accordance with one embodiment.

FIG. 17 illustrates an example of a sequence flow in accordance with one embodiment.

### DETAILED DESCRIPTION

Embodiments disclosed herein are generally directed to systems and methods for synchronizing authentication attempts, including when a contactless card is used in connection with an offline transaction. For example, the contactless card can be used in connection with an offline transaction, for example, to confirm an identity of an authorized cardholder. Each interaction with the contactless card increments a counter, such as an application transaction counter (ATC), stored on the contactless card. However, when a mobile device, such as a mobile phone or the like, communicates with the contactless card during the offline transaction, a corresponding counter stored on a server that is used to authenticate the contactless card fails to increment in a corresponding manner because offline transactions need not communicate with the server to confirm the identity of the authorized cardholder. As such, the counter stored on the contactless card will be out of sync with the corresponding counter stored on the server, which may result in the contactless card being declined and/or deactivated when used in connection with a future online transaction that communicates with the server to authenticate the contactless card.

However, embodiments disclosed herein can synchronize the counter stored on the contactless card with the corresponding counter stored on the server as follows. When the mobile device authenticates the contactless card in the offline transaction, for example, via offline data authentication, the mobile device can send a message to the server indicating that the mobile device successfully authenticated the contactless card with primary authentication data received from the contactless card. For example, the primary authentication data can include encrypted data, a public key, or a primary account number (PAN) of the contactless card.

Responsive to receiving the message from the mobile device, the server can authenticate the contactless card with secondary authentication data. For example, the secondary authentication data can include encrypted data, a phone number of the mobile device, or a geolocation of the mobile device. When the secondary authentication data includes the encrypted data, the server can decrypt the encrypted data to authenticate the contactless card with the secondary authentication information. When the secondary authentication data includes the phone number of the mobile device, the server can compare the phone number of the mobile device with a phone number associated with the contactless card, and when there is a match therebetween, authenticate the contactless card with the secondary authentication information. When the secondary authentication data includes the geolocation of the mobile device, the server can compare a geolocation of the mobile device with approved geolocations associated with the contactless card, and when there is a match therebetween or the geolocation of the mobile device is within a predetermined distance from the approved geolocations, the server can authenticate the contactless card with the secondary authentication information.

Responsive to authenticating the contactless card with the secondary authentication data, the server can update, for example, by incrementing, a counter value associated with the contactless card and stored on the server to synchronize the counter value stored on the server with the counter stored on the contactless card. In some embodiments, the server can post a dummy transaction or a preauthorization in a record of transactions associated with the contactless card to update the counter value associated with the contactless card. Additionally or alternatively, in some embodiments, the server can instruct an internal or external processor to update the counter value associated with the contactless card in an internal or external database. Additionally or alternatively, in some embodiments, the server can record an updated version of the counter value associated with the contactless card in an authentication cryptogram as a last successful authentication attempt and/or a last successful counter value.

Advantageously, systems and methods disclosed herein can synchronize the counter stored on the contactless card and the counter value stored on the server and associated with the contactless card so as to artificially synchronize authentication attempts outside of traditional online transactions. Indeed, by updating the counter value stored on the server without a traditional online transaction and authentication attempt that would automatically do so, the counter value stored on the server can remain synchronized with the counter stored on the contactless card so that future use of the contactless card in online transactions can successfully authenticate the contactless card without any issues related to mismatched counters.

Details of the above-identified embodiments and additional advantages thereof are discussed in the following description.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identify, perform a payment, launch applications, login into applications, autofill a form or a field, navigate to a specified web location or application on a device, unlock a door, initiate a contactless card, verify themselves, and so forth.

The systems discussed here may enable users to perform these functions in a multi-issuer environment. Further, the systems discussed herein may enable card issuers or payment providers, such as a banks, to issue contactless cards with tap-to functions to customers while maintaining a high-level security. The systems discussed differ from previous solutions because they provide a single platform for multiple issuers to provide the tap-to functionality. Traditionally, each issuer must set up and maintain their own systems to provide contactless card features. This includes maintaining their own hardware, software, databases, security protocols, and so forth, which can become extremely costly for the issuer to maintain. However, embodiments discussed enable issuers to offload much of the processing, storage, and security functionality to a neutral or central system. As will be discussed in more detail, the central system is configured to provide contactless card features for multiple issuers while maintaining a high level of security and data integrity. Each issuer's functionality and data may be separately managed and secured such that one issuer cannot access another issuer's data or functions. As will be discussed in more detail, these features may be provided by a switchboard system that is configured to process and perform each contactless card function in a secure manner. Additional benefits for issuers may include providing a highly secure authentication option for a mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. In some embodiments, embodiments discuss herein can also support tap-to-mobile web experiences on mobile platforms by leveraging Instant Apps. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for NFC between the mobile device and the contactless card, installing a native app via App Clips®, and functionality to obscure data and/or portions of a display. In one example, the SDK may be configured to download and install the app from an app store, such as Apples® App Store.

In the Android® operating system environment, embodiments include utilizing a JavaScript SDK. The JavaScript SDK may be installed into a website, e.g., via website source code. The JavaScript SDK also includes functions to support NFC between the mobile device and the contactless card via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner and other JavaScript UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include one or more apparatus specially constructed for the required purpose or a digital computer. Various embodiments also relate to one or more apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

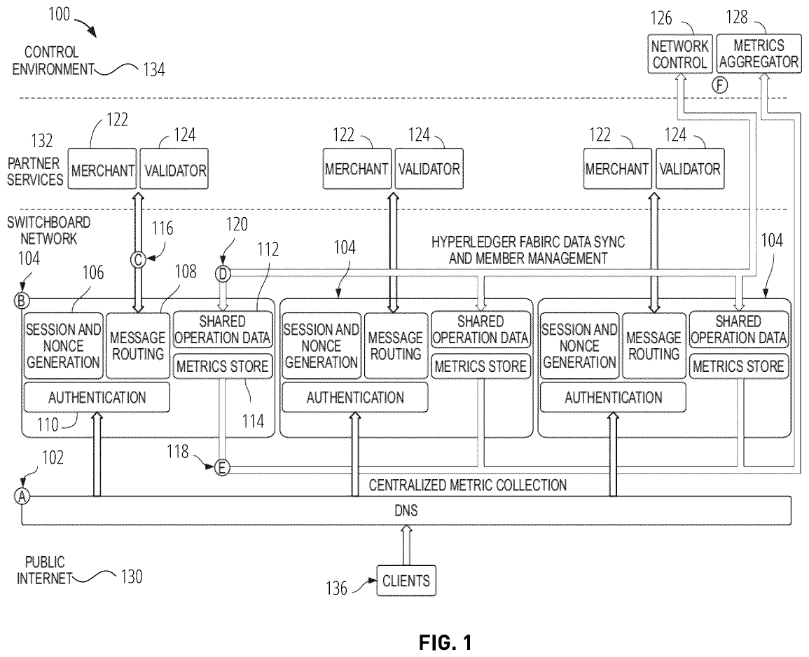

FIG. 1 illustrates an example of system 100 configured to operate in accordance with the embodiments discussed herein. The system 100 includes additional devices and systems configured to enable contactless card issuers to tap-to provide card services. Specifically, the system 100 enables any number of issuer systems to provide card services to their clients through a switching fabric, i.e., a switchboard system, in a secure and safe manner.

In embodiments, the switchboard system includes one or more nodes 104 configured to perform routing operations. Each switchboard node 104 may include a session and nonce generator 106, a message router 108, an authentication 110 function, an operation data 112 store, and a metrics store 114. Further, each of the nodes may be configured the same and share configurations, but each switchboard node 104 may independently process and route messages and requests to the appropriate systems, such as merchant systems and issuer systems. Each of the nodes 104 is configured to act as a broker of trust between an issuer system, a merchant system 122, and/or a validation system 124, for example. Each switchboard node 104 is configured to route each message to the correct issuer system while maintaining data security. For example, a switchboard node 104 may route a message between an issuer system and a merchant system while the node cannot access the private data in the message.

The switchboard system 100 may be configured as a server system with a collection of hardware, software, and networking components that work together to provide client services. Hardware components may include one or more server computers, storage devices, and network adapters. The server computers are configured to run server applications, such as those executable on each of the nodes 104. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

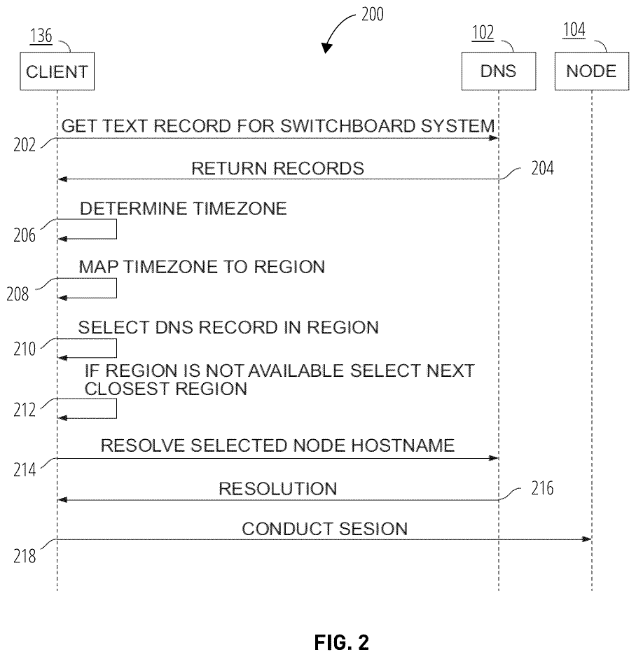

In some embodiments, the nodes 104 may operate in a cloud-based computing environment, e.g., a collection of hardware, software, and networking components that enable the delivery of cloud computing services. The switchboard nodes 104 and the computing services are delivered over the Internet and can be accessed from anywhere in the world with an Internet connection. In embodiments, client 136 may access a switchboard node 104 through a DNS 102 or a Domain Name System (DNS). The DNS 102 is a hierarchical and distributed naming system for computers, services, and other resources connected to the Internet or other networks. It associates various information with domain names assigned to each registered participant. In one example, the DNS 102 may translate a name known to software executing on a client 136 to route data to one or more of switchboard node 104 of the switchboard system. In embodiments, the DNS 102 may generate a number, such as an Internet Protocol (IP) address, an address record (A-record), or another Hostname (C-name record). FIG. 2 illustrates an example a sequence 200 for a client to identify and resolve an identifier for one of the nodes 104 of the switchboard system. At a high level, the DNS 102 translates known domain names to numerical Internet Protocol (IP) addresses needed for locating and identifying computer services and devices with the underlying network protocols. Clients use the global DNS system to select the best node to use, as illustrated in the sequence 200.

In embodiments, a client 136 communicates with the switchboard system to perform one or more partner services 132, such as conducting a transaction with a merchant, validating the customer, or other tap-to functions. Once the client 136 identifies a switchboard node 104 and resolves an address to communicate with the switchboard node 104, the client 136 may send one or more messages to the switchboard node 104 to authenticate and perform a desired operation. The switchboard node 104 includes an authentication 110 function that is configured to authenticate the client 136. In embodiments, the client 136 sends a message or authorization request to the switchboard node 104 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client ID | Individual identifier of client |
| GReyx5BuEAaE72bWbFZJfHRL8Dbt1Uum | Client Key | Randomly assigned key |

The switchboard node 104 may authorize or authenticate the client 136 or user, and the switchboard node 104 may utilize the additional components, such as the session and nonce generator 106 and the message router 108, to perform the operations. Note the validation system 124 never interacts with the merchant systems 122, nor vice versa. The nodes 104 brokers all communication.

In embodiments, the switchboard system may utilize a hyper ledger fabric 120 to manage and synchronize the shared operation data 112 and member management across the network. The hyper ledger fabric 120 is a distributed ledger framework having a permissioned network model that ensures only authorized participants can join the network and access the data that is stored on a ledger.

In embodiments, the hyper ledger fabric 120 may be generated by creating one or more sets of peers, an ordering service, and a channel. Once the network is created, the system 100 deploys chaincode to the network, or a node 104 is permitted to access the fabric. The chaincode is the code that runs on a blockchain and executes a network control 126 and operation data 112 logic code. Once the chaincode is deployed, each of the switchboard nodes 104 is configured to invoke transactions on the blockchain to add data to the blockchain, e.g., operational data. A switchboard node 104 or another device can query the ledger to retrieve data. The ledger is a distributed database that stores all the data added to the blockchain.

All nodes 104 keep an independently verifiable log of their actions that can be transmitted to a centralized aggregator to build a picture of overall network usage. The system 100 can manage network operation data and management at a central level and have a centralized view of network use, aggregated and abstracted to the appropriate level.

FIG. 2 illustrates an example a sequence 200 for a client to utilize the DNS to resolve and communicate with one or more nodes of the switchboard system. The illustrated sequence 200 includes a client 136, a DNS 102, and a switchboard node 104. At 202, the sequence 200 includes the client 136 sending a request to a default DNS server for a text record switchboard. {domain}. {tld}. The text record may be preconfigured in a client app and/or a client SDK. At 204, the DNS 102 returns one or more records. A DNS record structure may include the following:
Root Record:
   Name: switchboard. {domain}. {tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      *etc.
   Used For determining where there are active nodes.
Node Record:
   Name: {nodename}.{operator}.{region}.switchboard.{domain}.{tld}
   Type: A/AAAA or CNAME
   Resolution: Actual node hostname or IP
   Used For: communicating with a node 104

In embodiments, the client 136 may determine the current timezone at 206. For example, the client app or the SDK may utilize a get current timezone function, such as in JavaScript: Intl.DateTimeFormat( ).resolvedOptions( ).timeZone). Embodiments are not limited in this manner, and the app or the SDK may determine the timezone via another/different function call. At 208, the client 136 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, regions can also be represented as a bidirectional graph structure with the edges representing geographic neighbors. For example, na-e<->na-w and sa<->na-w and sa<->na-e. This representation is useful for node selection.

At 210, the client 136 may identify or select a DNS record option returned at 204 that is in the region. If there are multiple matches, the client 136 may select one at random. If there is no node available in the region, the client 136 may determine and use a data graph of neighboring regions to select a node in the closest region where a node is available at 212. For example, sa has no node but is connected to na-e where there is a node and so na-e is selected.

At 214, the client 136 may resolve a selected node's hostname. In embodiments, the client 136 may automatically resolve the hostname using the client's HTTP request default resolver. At 216, the DNS 102 may return a result, and at 218, the client 136 may communicate with a switchboard node 104 and begin the process to interact with the switchboard.

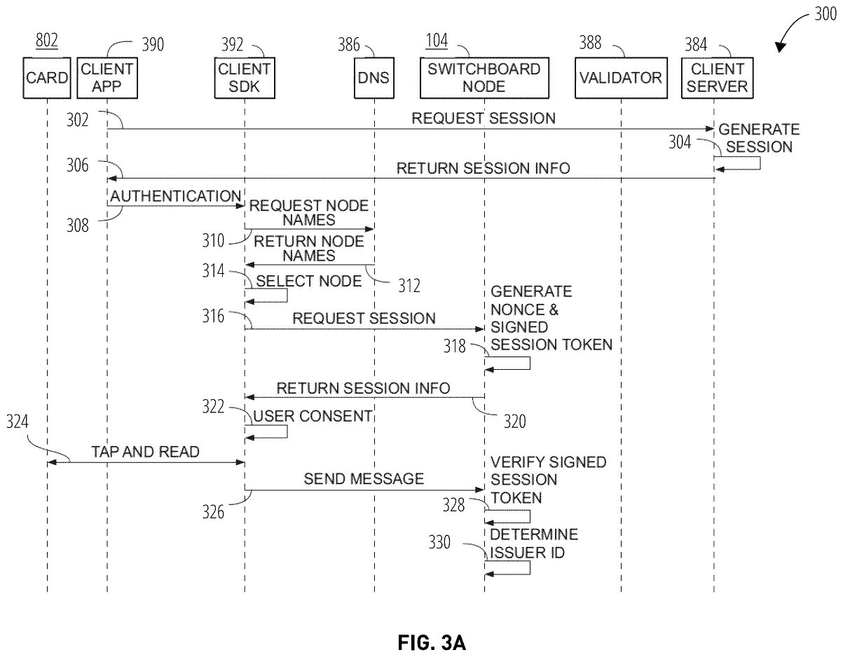

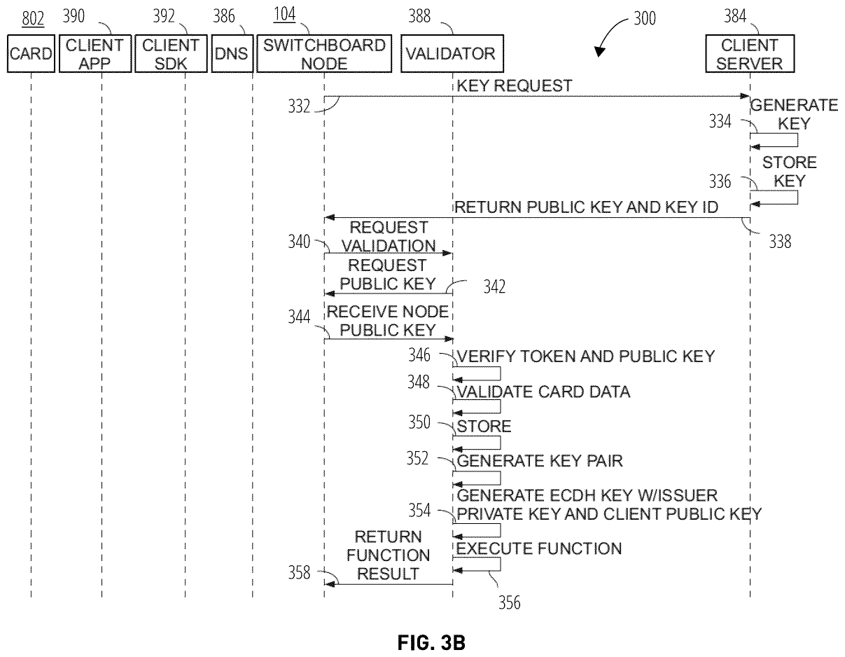

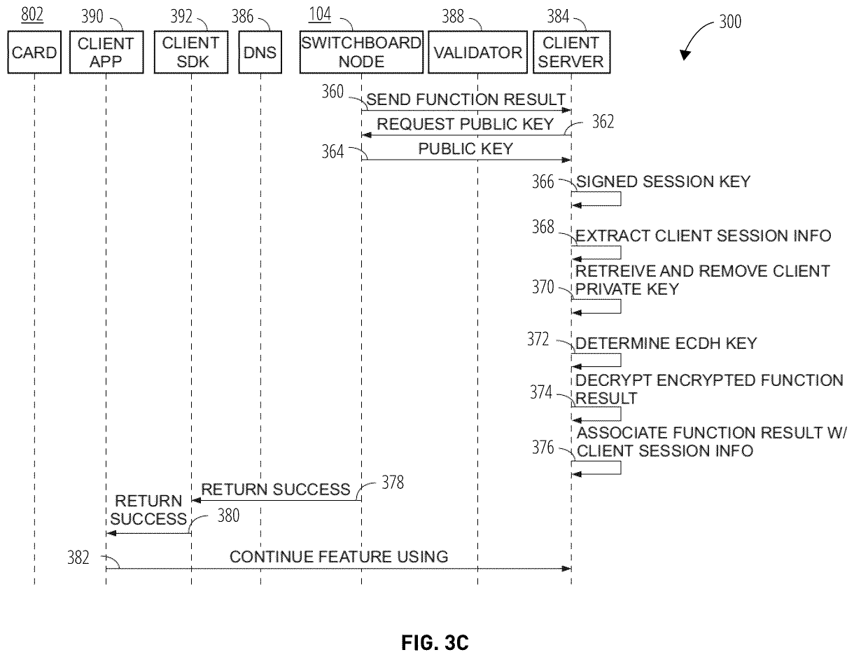

FIG. 3A-FIG. 3C illustrate an example of a sequence 300 to perform operations between a contactless card and services provided by a card issuer and/or a merchant. The illustrated sequence 300 includes actions and communications performed by a contactless card 802, a client 136, including a client app 390 and a client SDK 392, a DNS 386, a switchboard system including one or more nodes 104, partner services 132, including a merchant and/or a validator 388, and control services 134, including a client server 384 or system. In embodiments, the client app 390 may be any application configured to execute on a client 136, such as a banking app, a merchant app, a social media app, a travel app, a gaming app, a productivity app, an entertainment app, and so forth. In embodiments, the client app 390 includes a web browser to provide websites and pages. The client app 390 may include and/or utilize the client SDK 392, which may be a set of instructions that enable the client app 390 to communicate with other components of the switchboard system.

In embodiments and as shown in FIG. 3A, at 302 the client 136, including the client app 390, may send a request and establish a session with a client server 384 such that a result may be associated with the correct client device or user. The request establishes a relationship between the client 136 and the client server 384, which may be an issuer server. At 304, the client server 384 generates a session and CLIENT SESSION INFORMATION. At 306, the client server 384 returns the session information, e.g., the CLIENT SESSION INFORMATION. In embodiments, the CLIENT SESSION INFORMATION may be client implementation-specific user session identification information.

At 308, the client 136 may initiate a contactless card authentication process with the client 136. For example, the client 136 may call a function and/or pass information to the client 136 to initiate authentication via a contactless card 802. At 310-314, the client 136 may utilize the DNS 386 to identify a node and establish communication with the node. Specifically, at 310, the client 136, including the client SDK 392, may send a request for switchboard hostnames, and at 312 the DNS 386 may return information including one or more hostnames. At 314, the client 136 may determine a switchboard node to communicate. FIG. 2 illustrates an example of a more detailed sequence 200 to establish communication with a switchboard node 104.

At 316, the client 136 may send a request for a session to the switchboard system 100. In embodiments, the request for the session may be a function request in the format <FUNCTION REQUEST>. In embodiments, the FUNCTION REQUEST may be the data/function that the client 136 would like to request once the contactless card 802 has been validated. The function could be for any service discussed herein, e.g., authenticate the user, perform a transaction, request autofill data, etc. At 318, the switchboard system 100 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with the contactless card 802. The nonce is critical to the security and operation of the switchboard system. The nonce validity is tracked by tying the nonce to a session that can be validated by any member of the platform. As mentioned, sessions are JSON Web Tokens signed using a node-specific private key issued by the network. These JWTs are verifiable by a system with the corresponding public key, which the system can also verify by confirming the JWT was issued by the network or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 100 private key. The switchboard system 100 may include a NODE PUBLIC/PRIVATE KEY, which is a keypair used to sign and validate JWTs.

At 320, the switchboard system 100 may return session information to the client 136. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 322, the client SDK 392 may determine and/or receive user consent to the terms of service. In one example, the client SDK 392 captures and records the user consent to <FUNCTION TOS> on <CONSENT DATE> with <TOS VERSION>. The CONSENT DATE may be the timestamp for the user's consent to the TOS.

At 324, the client 136 exchanges one or more messages with the contactless card 802. In one example, the exchange may be based on the contactless card being tapped to a client device. In embodiments, the client SDK 392 may provide data to the contactless card 802 to use during the session to perform the function. The data may be provided to the contactless card 802 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message Tag | D1 (only record) |
| 01 | Length of Record | 01 |
| | Type | |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX encoded 4 bytes binary data |
| 0F . . . 12 | Session Indicators | 4 bytes of ASCII HEX encoded 2 bytes binary data |
| 13 . . . 16 | Control Indicators | 4 bytes of ASCII HEX encoded 2 bytes binary data |
| 17 . . . 26 | Update Date | 16 bytes of ASCII HEX encoded 8 bytes binary data - |
| | creation Time | represents 64 bit unix timestamp |
| 27 . . . 36 | Update MAC | MAC to protect control indicators - 16 bytes of ASCII |
| | | HEX encoded 8 bytes binary data |

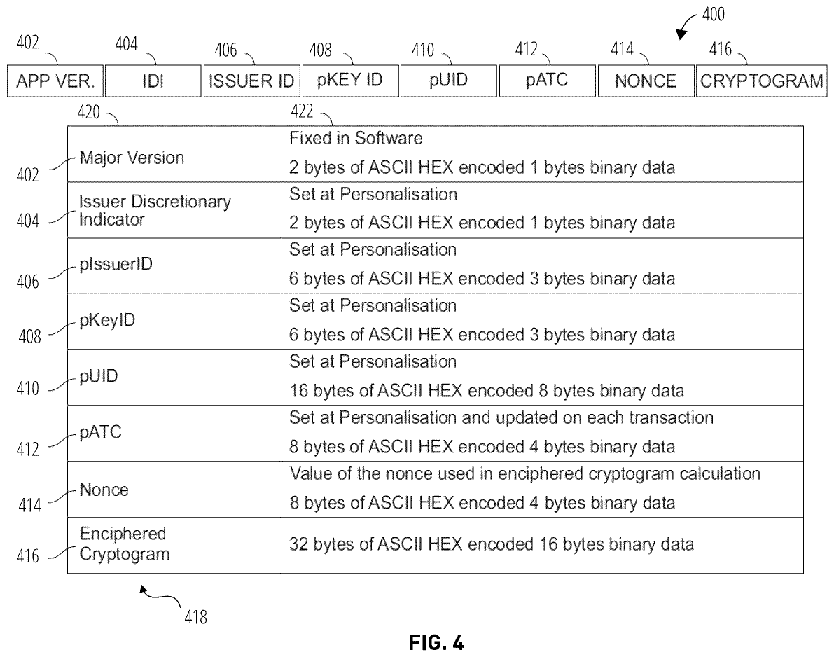

The updated MAC may be calculated to protect the control indicators in embodiments. Specifically, The MAC M is determined by calculating a MAC over the 10 bytes of the update data U with the Update MAC Card Key (MCK), as described in FIG. 4.

At 324, the contactless card 802 may generate and provide a message to the client's device, including the client SDK 392. The data in the message may be utilized by the system discussed herein to perform the function requested. One example of the message is illustrated and discussed in FIG. 4.

At 326, the client, including the client SDK 392, may send a message and information to the switchboard system 100. The message may be the message received from the contactless card 802, e.g., message 400 in FIG. 4. In addition, the client SDK 392 may send the consent date, the TOS version, and the signed session token to the switchboard system 100. The switchboard system 100 may utilize the information to ensure the session is valid. At 328, the switchboard system 100 verifies the signed session token is valid, e.g., is the previously provided signed session token and includes the nonce previously generated and in the message.

In some embodiments, the switchboard system 100 is configured to determine which issuer system or client-server it should route the message to for processing. At 330, the switchboard system 100 may determine the issuer ID by extracting the issuer ID from the message received from the contactless card 802 via the client SDK 392. As mentioned, the issuer ID identifies the issuer of the contactless card 802.

FIG. 3B continues the sequence 300 from FIG. 3A. In embodiments, the switchboard system 100 is configured to generate and communicate secure communications with the issuer system, e.g., the client server 384 and the validator 388. At 332, the switchboard system 100 sends a request for a key to the client server 384. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 334, the client server 384 generates a portion of the key. In some instances, the client server 384 may generate half of the ECDH key for encryption/decryption of PII. Specifically, the client server 384 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 336, the client-server 384 stores the generated portion of the key in storage. Specifically, the client server 384 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 384 may return the public key portion to the switchboard system 100 with the KEY ID at 338. The switchboard system 100 may store the public key portion with the KEY ID for later use, e.g., generation of the ECDH key. At 340, the switchboard system 100 may request a validation to be performed by the validator 388. In one example, the switchboard system 100 may send a request validation as Request Validation <MESSAGE>, <SIGNED SESSION TOKEN>, <CLIENT EC PUBLIC KEY>, <CONSENT DATE>, and the <TOS VERSION>. The validator 388 may make an out-of-band request back to the switchboard system 100 for the public key to verify the session at 342. At 344, the switchboard system 100 may provide the node's public key, i.e., <NODE PUBLIC KEY>. Further at 346, the validator 388 may utilize the node's public key to verify the secure session token.

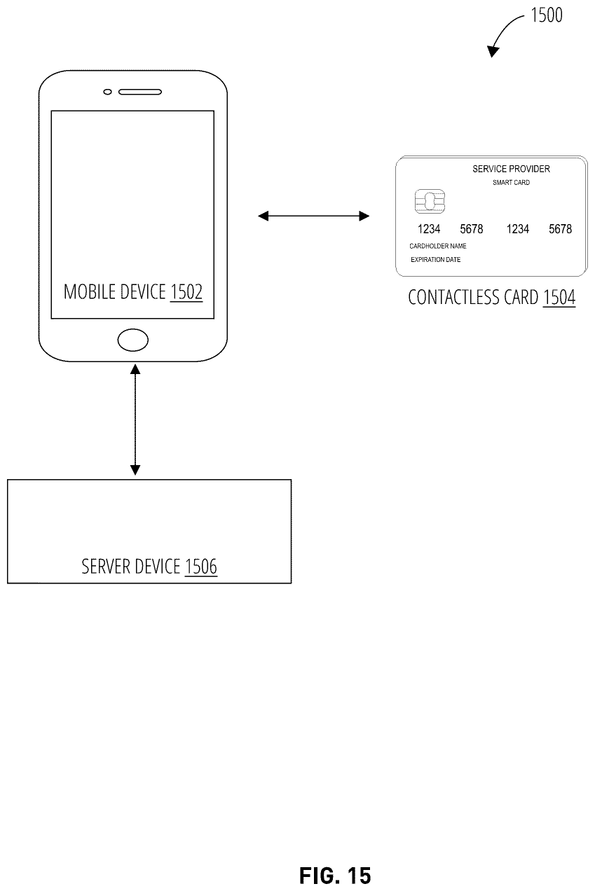

In embodiments, the validator 388 may validate the message at 348. In embodiments, the validator 388 may perform a number of validations including ensuring the nonce in the message is correct along with additional information, such as the card's unique identifier (pUID), and the counter value (pATC). FIGS. 15-17 discuss additional details of a validation process that may be performed.

At 350, the validator 388 may store information associated with the session. For example, the validator 388 may store the <CONSENT DATE> with the <TOS VERSION> and the <PUID>. The validator 388 may also generate another portion of the key, e.g., the ECDH key. For example, the 388 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 354, the validator 388 may generate the complete ECDH key. For example, the validator 388 generates the <ECDH KEY> from <ISSUER EC PRIVATE KEY> and <CLIENT EC PUBLIC KEY>. The ECDH KEY is the final key generated using ECDH key negotiation.

The validator 388 may utilize the ECDH KEY to encrypt data for the function. For example, if the validator 388 validates the message in some instances, the validator 388 may execute a function request to create a function result and encrypt the result with the ECDH KEY at 356. For example, the validator 388 may execute <FUNCTION REQUEST> to create <FUNCTION RESULT> and encrypt the same with the <ECDH KEY>. The function result may be any result based on the requested function, e.g., verification of the card.

At 358, the validator 388 may return the function result to the switchboard system 100. In some instances, the function result is returned encrypted. For example, the validator 388 may return the <ENCRYPTED FUNCTION RESULT> and the <ISSUER EC PUBLIC KEY>.

FIG. 3C continues the sequence 300 from FIG. 3B. In embodiments, at 360, the switchboard system 100 sends the function result to the client server 384 to process the result. In one example, the switchboard system 100 may send the <ENCRYPTED FUNCTION RESULT>, <KEY ID>, <ISSUER EC PUBLIC KEY>, and <SIGNED SESSION TOKEN>. At 362 and 364, the client server 384 may make a request for and receive the public key from the switchboard system 100. In some instances, the exchange may be performed via out-of-band communication channels. The public key for the node may be <NODE PUBLIC KEY>. The public key may be used to verify the sender of the function result, etc. At 366, the client server 384 may verify the signed session key with the node's public key <NODE PUBLIC KEY> to verify the sender of the information. At 368, the client server 384 may extract client information from the signed session token. For example, the client server 384 may Extract <CLIENT SESSION INFO> from <SIGNED SESSION TOKEN>, i.e., extracting the client implementation-specific user session identification information.

Further, at 370, the client server 384 may retrieve the client's private key with the KEY ID. Specifically, the client server 384 may get and remove the <CLIENT PRIVATE KEY> from a cache using the <KEY ID>. At 372, the client server 384 may generate or compute the ECDH key. For example, the client server 384 may compute the <ECDH KEY> with the <CLIENT PRIVATE KEY>+<ISSUER EC PUBLIC KEY>. The client server 384 may decrypt the function result with the computed key at 374. Specifically, the client server 384 may decrypt the <ENCRYPTED FUNCTION RESULT> with the <ECDH KEY> to determine the <FUNCTION RESULT>. At 376, the client server 384 associates the function result with the session.

In embodiments, the switchboard system 100 may return whether the function result was successfully completed or not at 378 to the client SDK 392. Further at 380, the client SDK 392 may notify the client app 390 of the result. At 382, the client app 390 may utilize the feature. For example, the 382 may communicate with the client server 384 to continue the feature using the <CLIENT SESSION INFO> to fetch the redacted <FUNCTION RESULT>.

FIG. 4 illustrates an example of a message 400 that may be communicated by a contactless card to perform the functions described herein, such as those discussed in FIGS. 3A-3C. One or more of the fields in the message 400 may also be utilized to route the message 400 through the switchboard system and perform authentication/validation techniques.

In embodiments, the message 400 includes an applet version 402 field, an issuer discretionary indicator 404 field, an Issuer Identifier 406 field, a pKey ID 408 field, a pUID 410 field, a pATC 412 field, a nonce 414 field, and an encrypted cryptogram 416.

In embodiments, the fields may be in plain text or encrypted. For example, the applet version 402 field may include an applet version in plain text. The applet version indicates which applet version is installed on a contactless card and may be used by the other systems to determine how to process the message 400 when communicated. For example, different Applet versions require different validation logic, e.g., an older message may be routed through the issuer system to perform various operations for validation, while a newer message may be routed through the switchboard system to perform the various operations, including validation.

In embodiments, the message 400 includes an issuer discretionary indicator 404 field that may include issuer data and be set at the time of personalization. In addition, the message 400 includes an issuer identifier 406 field that may include a unique ID assigned to the entity issuing the card, e.g., the issuer. For example, when joining the system, each issuer may be assigned a unique identifier during an onboarding operation. The issuer ID can be used by the switchboard system 100 to route a message and its contents to the appropriate services that are associated with that particular issuer.

In embodiments, the message 400 includes a pKey ID 408 field. In some instances, the pKey ID 408 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 802 is given a unique 16-decimal digit identity (pUID) at the time of personalization. Derivation of the card applet's unique keys using the pUID is performed off-card. The resultant application keys are injected during the personalization of the card. In embodiments, a card's application keys are the same as the card's derived master keys or UDKs.

The message 400 may include a pUID 410 field, including a card unique identifier assigned to the contactless card at personalization time. The pUID 410 field data may be a combination of alphanumeric characters used to identify each card and associated with a user uniquely.

In embodiments, the message 400 includes a pATC 412 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 400 is created, a new session key is derived and utilized to generate one or more portions of the message 400. Specifically, a session key is used to calculate the cryptographic MAC (Application Cryptogram). The card's applet supports a session key derivation option to generate a unique cryptogram session key (ASK) and a unique encipherment session key (DESK).

In embodiments, a portion of the data provided in message 400 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 802 may communicate a message between a device, such as a mobile device, during a read operation. For example, in response to the contactless card 802 being tapped onto a surface of the device, e.g., brought within wireless communication range, a read operation may be performed on the contactless card 802, and the contactless card 802 may generate and provide the message to the device. For example, once within range, the contactless card 802 and the device may perform one or more exchanges for the contactless card 802 to send the message to the device.

The wireless communication may be in accordance with a wireless protocol, such as near-field communication (NFC), Bluetooth, WiFi, and the like. In some instances, a message may be communicated between a contactless card 802 and a device via wired means, e.g., via the contact pad, and in accordance with the EMV protocol.

As discussed above, the contactless card 802 may be deployed with a unique card key, e.g., the UDK, that is generated from an issuer's master key and is used to generate session keys. The following discusses the generation of the UDK and the session keys (ASK and DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 802. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacture, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID or a pUID, a card application's unique 16-decimal digital identity, to a card. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc., may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 802 stores the generated application key(s) or UDK(s).

In embodiments, the contactless card 802 utilizes the application key(s) or UDK(s) to generate session keys for each encrypted data is generated. The following is one processing flow that may be performed by the contactless to generate a unique cryptogram session key (ASK).

To generate the ASK, the contactless card 802 computes an SKL by encrypting [ATC[2]∥ATC[3]∥‘F0’∥‘00’∥[ATC[0]∥[ATC[1]∥[ATC[2]∥[ATC[3]] with an application key. Further, the contactless card 802 computes SKR by encrypting [ATC[2]∥ATC[3]∥‘0F’∥‘00’∥[ATC[0]∥[ATC[1]∥[ATC[2]∥[ATC[3]] with the application key. Finally, the contactless card 802 concatenates SKL with SKR to form an authentication session key (ASK). In embodiments, the ASK is used to perform operations utilizing the contactless card 802, such as encrypting the cryptographic MAC.

In embodiments, the contactless card 802 also supports session key derivation to generate a unique encipherment session key DESK. The contactless card 802 computes an SKL by encrypting [ATC[2]∥ATC[3]∥‘F0’∥‘00’∥‘00’∥‘00’∥‘00’ ∥ ‘00’] with a Data Encryption Key (DEK) or UDK. Further, the contactless card 802 computes SKR by encrypting [ATC[2]∥ATC[3]∥‘0F’∥‘00’∥‘00’∥‘00’∥‘00’∥‘00’] with the DEK or UDK. The contactless card 802 concatenates SKL with SKR to form the Data Encipherment Session Key (DESK).

In embodiments, the contactless card 802 generates encrypted data or a cryptogram utilizing the session keys. Specifically, the contactless card 802 generates a cryptogram C by calculating a MAC over the 32-byte transaction data T using the Authentication Session Key (ASK).

The contactless card 802 may process the data to generate the cryptogram. Specifically, the contactless card 802 divides T into four blocks of 8 bytes of data: T=T1∥T2∥T3∥T4. The contactless card 802 computes B=DES (ASKL) [T1], where DES is the Data Encryption Standard or another symmetric encryption algorithm and ASKL is a portion of the ASK, e.g., the “left” half of the key. The contactless card 802 computes B=[B XOR T2], and the contactless card 802 computes B=DES (ASKL) [B]. The contactless card 802 computes B=[B XOR T3], and the contactless card 802 computes B=DES (ASKL) [B]. The contactless card 802 computes B=[B XOR T4], and the contactless card 802 computes B=DES (ASKL) [B]. The contactless card 802 computes B=DES⁻¹ (ASKR) [B], where DES⁻¹ is the reciprocal DES operation and ASKR is a portion of the ASK, e.g., the right half. The contactless card 802 computes the cryptogram C=DES (ASKL) [B].

In embodiments, the contactless card 802 may also encipher the cryptogram to secure the data further. For example, the contactless card 802 may generate an 8-byte random number [RND] and the card computes E1=DES3 (DESK) [RND], where DES3 is a symmetric encryption algorithm such as the Triple Data Encryption Standard. The contactless card 802 then computes B=[E1] XOR [C], where C is the cryptogram generated as discussed above. The contactless card 802 computes E2=DES3 (DESK) [B], where B is computed above. Further, the contactless card 802 generates the 16-byte enciphered payload E=[E1]∥[E2].

In embodiments, a device or the contactless card 802 may decrypt the payload E by determining, receiving, or retrieving the payload E. The device computes a RND=DES3⁻¹ (DESK) [E1]. The device determines B=DES3⁻¹ (DESK) [E2], and the device computes C=[E1] XOR [B].

In embodiments, the contactless card 802 generates or calculates a message authentication code (MAC). In some instances, the MAC may be an updated MAC. In embodiments, the updated MAC is included in data communicated from the contactless card 802 to another device, such as a mobile device, a point-of-sale (POS) terminal, or any other type of computer. In one example, the updated MAC may be included in an NDEF message.

In embodiments, the updated MAC may be calculated to protect the control indicators and include an updated date/time. For example, the updated MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES (MCKL) [U1], where DES is a Data Encryption Standard algorithm using a first portion (L) of the MAC Card Key (MCKL).

Further, an additional operation may be performed on the result B. Specifically, the result B may be exclusively or′d (XOR) with a second portion of the data (U₂).

The updated result B may be further processed. For example, result B may be further processed by applying the DES algorithm using MCKL again to B. The result, the inverse DES, may process B with a second portion (R) of the MCK (MCKR), and the MAC M may be determined by applying the DES algorithm with the MCKL to result B.

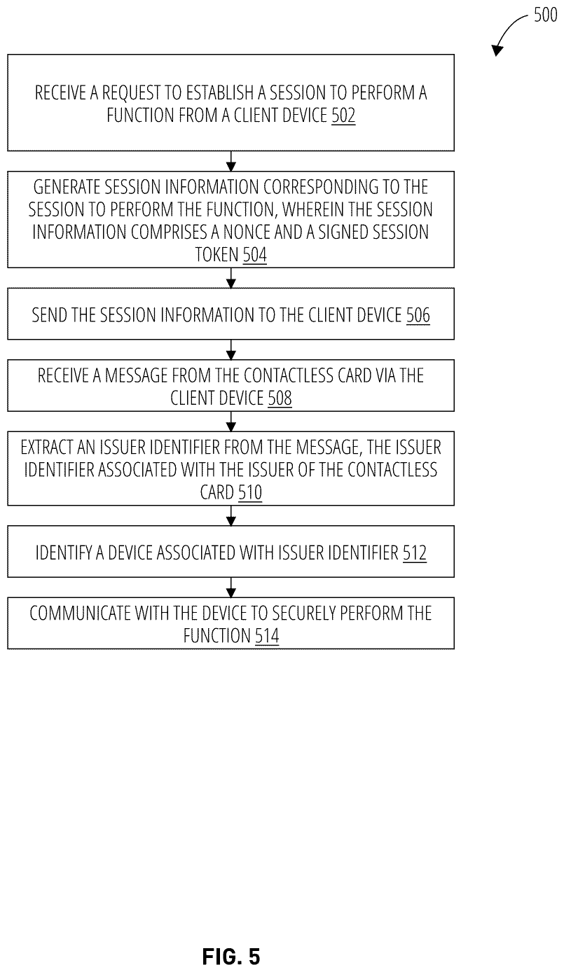

FIG. 5 illustrates an example of method 500 in accordance with embodiments discussed herein. In block 502, the method 500 includes receiving, by a node in a system, a request to establish a session to perform a function from a client device, wherein the function is at least partially performed utilizing a contactless card, such as the contactless card 802. In some instances, the node may be one of a plurality nodes of a switchboard system. The node may be previously selected by the sending device via a DNS operation performed.

In block 504, the method 500 includes generating, by the node, session information corresponding to the session to perform the function, wherein the session information comprises a nonce and a signed session token. The nonce and/or the signed session token may be utilized by systems to perform the functions described herein while ensuring the node routing the data is authenticated, the message from the contactless card is authenticated, and to keep track of the session for the function.

In block 506, the method 500 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node incorporates the nonce into a cryptographic portion of the message (see, e.g., FIG. 4).

In block 508, the method 500 includes receiving, by the node, a message from the contactless card via the client device. The message may be generated by the contactless card. FIG. 4 illustrates one example of a message 400. In some embodiments, the node verifies the message. For example, the node may verify a nonce in the message and a signed session token.

In block 510, the method 500 extracts an issuer identifier from the message by the node, where the issuer identifier is associated with the issuer of the contactless card. In some instances, the issuer identifier may be in a plaintext format.

In block 512, the method 500 identifies, by the node, a device associated with the issuer identifier. For example, the node may perform a lookup to determine a server associated with the issuer identifier and the function to be performed.

In block 514, the method 500 communicates, by the node, with the device to securely perform the function.

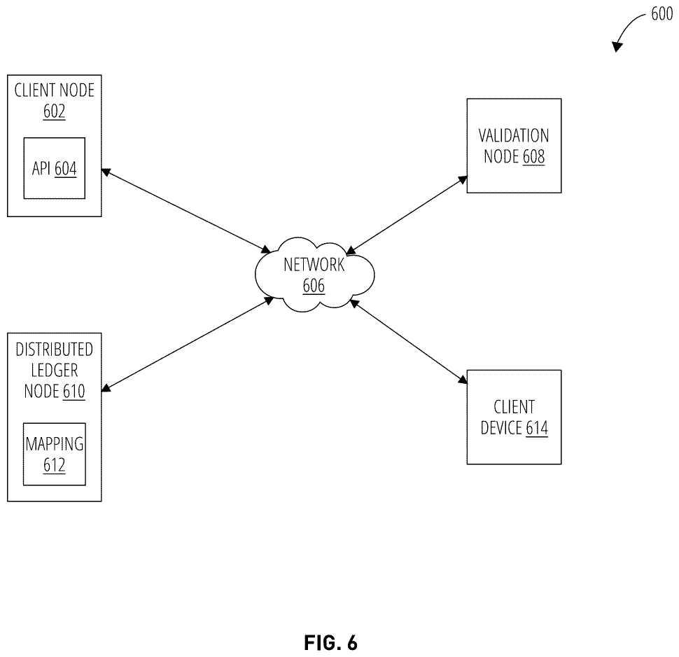

FIG. 6 illustrates a distributed network authentication system 600 according to an example embodiment. As further discussed below, the system 600 can include a client node 602, an API 604, a network 606, a distributed ledger node 610, mapping 612, and a client device 614. Although FIG. 6 illustrates single instances of the components, the system 600 can include any number of components.

The system 600 can include the client node 602, which can be a network-enabled computer as described herein. In some examples, the client node 602 can be a server, which can be a dedicated server computer or a bladed server, or can be a personal computer, a laptop computer, a notebook computer, a palm top computer, a network computer, a mobile device, a wearable device, or any processor-controlled device capable of supporting the system 600.

In some examples, the client node 602 can execute one or more applications, such as software applications, that enable, for example, network communications with one or more components of the system 600, transmit and/or receive data, and perform the functions and processes described herein.

The client node 602 can contain the API 604. For example, various different APIs can be provided for an application (e.g., executed on a computing device, such as a network-enabled computer) that can interact with a service. For example, an application executed on a device (e.g., a smart phone, smart watch, tablet, laptop, or other device) can interact with a web-based service by calling the API 604 to interact with the service, such as by performing a remote call to an API for interacting with a web-based service.

The API 604 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

The client node 602 can communicate with one or more other components of the system 600 either directly or via the network 606. The network 606 can comprise one or more of a wireless network, a wired network, or any combination of a wireless network and a wired network and may be configured to connect the components of the system 600. While FIG. 6 illustrates communication between the components of the system 600 through the network 606, it is understood that any component of the system 600 can communicate directly with another component of the system 600, e.g., without involving the network 606.

The system 600 can include a validation node 608, which can be a network-enabled computer as described herein. In some examples, the validation node 608 can be a server, which can be a dedicated server computer or a bladed server, or can be a personal computer, a laptop computer, a notebook computer, a palm top computer, a network computer, a mobile device, a wearable device, or any processor-controlled device capable of supporting the system 600.

In some examples, the validation node 608 can execute one or more applications, such as software applications, that enable, for example, network communications with one or more components of the system 600, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

The system 600 can include the distributed ledger node 610, which can be a network-enabled computer as described herein. In some examples, the distributed ledger node 610 can be a server, which can be a dedicated server computer or a bladed server, or can be a personal computer, a laptop computer, a notebook computer, a palm top computer, a network computer, a mobile device, a wearable device, or any processor-controlled device capable of supporting the system 600.

In some examples, the distributed ledger node 610 can execute one or more applications, such as software applications, that enable, for example, network communications with one or more components of system 600, transmit and/or receive data, and perform the functions and processes described herein.

The distributed ledger node 610 can containing the mapping 612. In some examples, the mapping 612 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of the system 600, or the one or more databases can be hosted externally to any component of the system 600. In some examples, the one or more databases can be contained in the distributed ledger node 610, and in other examples the one or more databases can be stored outside of distributed ledger node 610 but in data communication with the distributed ledger node 610. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within the distributed ledger node 610. In other examples, the one or more databases can be remote from distributed ledger node 610 but in data communication with the distributed ledger node 610. Data communication between the one or more databases and the distributed ledger node 610 can be a direct data communication or data communication via a network, such as the network 606.

In some examples, the client node 602 can be in data communication with the distributed ledger node 610. The distributed ledger node 610 can contain the mapping 612, and the mapping 612 may include, for example, a mapping between a validation node address and the validation node 608, a mapping between a routing number and a validation node address, and/or a mapping between a routing number and the validation node 608. In some examples, the mapping 612 can include a digital signature associated with an entity having permission to validate for a routing number. Based on one or more of these associations, the client node 602 can call the validation node 608 for validation and/or provide direction to the client device to reach the appropriate validation node. This can be accomplished by calling a validation API associated with the validation node 608.

In some examples, iterations of the mappings described herein, such as the mapping 612, can also include a software or applet version number. The version number can be used to identify a validation node or validation node address or choose between multiple validation addresses for one validation node.

In some examples, the client node 602 and the distributed ledger node 610 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, the distributed ledger node 610 can update the mapping 612 to reflect a different association between, for example, a routing number, a validation node address, and a validation node. In some examples, degrees of permissions can be issued. For example, if the client node 602 were to function to route data to the validation node 608 (or other validation nodes), then the client node 602 can be given a certain level of permissions. As another example, if the distributed ledger node 610 were to have the capability to update the mapping 612, then the distributed ledger node 610 can have a different, higher level of permissions.

The system 600 can include the client device 614, which can be a network-enabled computer as described herein. In some examples, the client device 614 can be a server, which can be a dedicated server computer or a bladed server, or can be a personal computer, a laptop computer, a notebook computer, a palm top computer, a network computer, a mobile device, a wearable device, or any processor-controlled device capable of supporting the system 600. The client device 614 can also be a mobile device; for example, a mobile device may include an iPhone, iPod, or iPad from Apple®, any other mobile device running Apple's iOS® operating system, any device running Microsoft's Windows® Mobile operating system, any device running Google's Android® operating system, and/or any other smartphone, tablet, or like wearable mobile device. In some examples, the client device 614 can be in data communication with another network-enabled computer not shown in FIG. 6, such as a smart card (e.g., a contactless card or a contact-based card).

In some examples, the client device 614 can execute one or more applications, such as software applications, that enable, for example, network communications with one or more components of the system 600, transmit and/or receive data, and perform the functions and processes described herein.

In some examples, upon receipt of an authentication request, the client device 614 can call (e.g., via an API) the client node 602. The call can include a routing number and/or an applet or software version number, and the client node 602 can query distributed ledger node 610 and the mapping 612. Once the query returns the identification of a validation node (e.g., the validation node 608) and/or a validation node address associated with that routing number and/or applet or software version, the client node 602 can reply to the client device 614. The client device 614 can then proceed with authentication with the validation node. The authentication can be performed by, for example, the systems and methods described herein, such as by generation, encryption, transmission, decryption, and validation of a cryptogram as described herein.

In some examples, the client node 602 can be co-resident with the validation node 608. In these examples, the client node 602 can handle the authentication in a single call from the client device 614. In some examples, this can be acceptable only if it is permissible for the full authentication transmission (e.g., a cryptogram as described herein) to be sent to client nodes that are not involved in authentication.

In some examples, if the client node 602 receives, from the client device 614, a routing number that is not handled by its location, the client node 602 can return a code indicating that this routing number is not handled, along with validation node address for the responsible validation node. The client device 614 can then send the full authentication transmission to the validation node 608 using the received validation node address.

In some examples, the client node 602 can enter the distributed network with different permissions. For example, the client node 602 can be a read-only router of data. As another example, the client node 602 can have permission to send messages to the distributed ledger node 610 updating one or more routing paths for one or more routing numbers. However, the client node 602 would be prevented from updating one or more routing paths for one or more routing numbers for other entities that control other routing numbers that are not associated with the client node 602 or that did not grant this permission. As another example, the distributed ledger node 610 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also revoke any of the foregoing. In some examples, the foregoing permissions can be delegated to the client node 602, the distributed ledger node 610, and/or the validation node 608 if security, legal, and/or financial conditions are met. However, delegation is not required.

In some examples, one or more APIs can facilitate communication between components of the system 600 via the network 606. In other examples, one or more APIs are not required. Rather, the components of system 600 could be in direct communication and/or dedicated to one or more specified entities to allow the specified entities to keep data from being transferred to, transferred from, or transferred via non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by the validation node 608 for authentication, can require storage of the keys in one or more HSMs, to promote key security and ensure that the keys are never entered into memory.

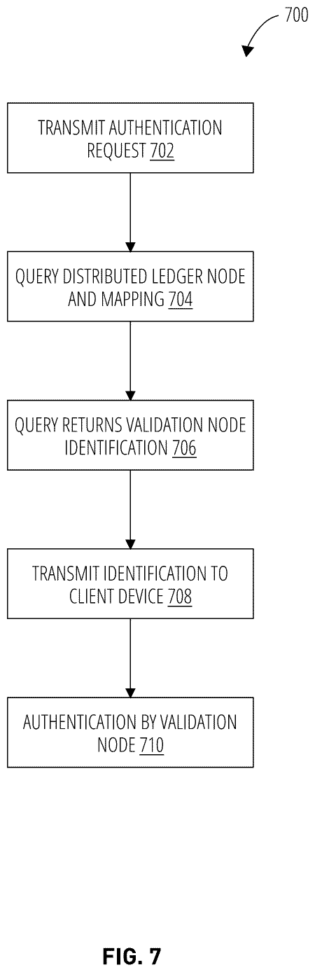

FIG. 7 illustrates a method 700 performed by a distributed network authentication system according to an example embodiment. For example, the method can be performed by the distributed network authentication system 600 and or by another distributed network authentication system.

In block 702, a client device can transmit an authentication request to a client node. The authentication request can include, without limitation, a routing number, a software version number, and/or an applet version number. The request can be made by an API call or other communication between the client device and the client node.

In block 704, after receiving the authentication request, the client node can transmit a query (e.g., via an API call) to a distributed ledger node. The distributed ledger node can contain a mapping, and the distributed ledger node can submit the query to the mapping.

In block 706, the query can return an identification of a validation node and/or a validation node address, and the distributed ledger node can transmit this identification to the client node.

In block 708, the client node can transmit the identification to the client device. After receiving the identification, the client device can proceed with authentication with the identified validation node and/or the identified validation node address, in block 710.

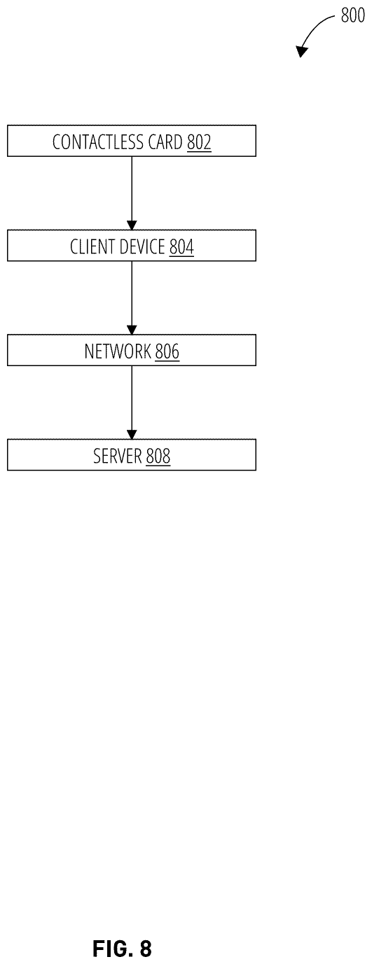

FIG. 8 illustrates a data transmission system 800 according to an example embodiment. As further discussed below, the system 800 may include a contactless card 802, a client device 804, a network 806, and a server 808. Although FIG. 8 illustrates single instances of the components, the system 800 may include any number of components.

The system 800 may include one or more contactless cards 802, which are further explained below. In some embodiments, the contactless card 802 may be in wireless communication, utilizing NFC in an example, with the client device 804.

The system 800 may include the client device 804, which may be a network-enabled computer. As referred to herein, a network-enabled computer may include, but is not limited to a computer device or a communications device including, for example, a server, a network appliance, a personal computer, a workstation, a phone, a handheld PC, a personal digital assistant, a thin client, a fat client, an Internet browser, or other device. The client device 804 also may be a mobile device; for example, a mobile device may include an iPhone, iPod, or iPad from Apple®, any other mobile device running Apple's iOS® operating system, any device running Microsoft's Windows® Mobile operating system, any device running Google's Android® operating system, and/or any other smartphone, tablet, or like wearable mobile device.

The client device 804 can include a processor and a memory, and it is understood that processing circuitry may contain additional components, including processors, memories, error and parity/CRC checkers, data encoders, anticollision algorithms, controllers, command decoders, security primitives and tamperproofing hardware, as necessary, to perform the functions described herein. The client device 804 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, the client device 804 may execute one or more applications, such as software applications that enable, for example, network communications with one or more components of the system 800 and transmit and/or receive data.

The client device 804 may be in communication with one or more server(s) 808 via one or more network(s) 806 and may operate as a respective front-end to back-end pair with the server 808. The client device 804 may transmit, for example, from a mobile device application executing on the client device 804, one or more requests to the server 808. The one or more requests may be associated with retrieving data from the server 808. The server 808 may receive the one or more requests from the client device 804. Based on the one or more requests from the client device 804, the server 808 may be configured to retrieve the requested data from one or more databases (not shown). Based on receipt of the requested data from the one or more databases, the server 808 may be configured to transmit the received data to the client device 804, the received data being responsive to the one or more requests.

The system 800 may include one or more networks 806. In some examples, the network 806 may be one or more of a wireless network, a wired network, or any combination of wireless network and wired network and may be configured to connect the client device 804 to the server 808. For example, the network 806 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, the network 806 may include, without limitation, telephone lines, fiber optics, IEEE Ethernet 802.3, a wide area network, a wireless personal area network, a LAN, or a global network, such as the Internet. In addition, the network 806 may support an Internet network, a wireless communication network, a cellular network, or the like, or any combination thereof. The network 806 may further include one network or any number of the exemplary types of networks mentioned above, operating as a stand-alone network or in cooperation with each other. The network 806 may utilize one or more protocols of one or more network elements to which the network 806 is communicatively coupled. The network 806 may translate to or from other protocols and to one or more protocols of network devices. Although the network 806 is depicted as a single network, it should be appreciated that according to one or more examples, the network 806 may comprise a plurality of interconnected networks, such as, for example, the Internet, a service provider's network, a cable television network, corporate networks, such as credit card association networks, and home networks.

The system 800 may include one or more servers 808. In some examples, the server 808 may include one or more processors, which are coupled to memory. The server 808 may be configured as a central system, server, or platform to control and call various data at different times to execute a plurality of workflow actions. The server 808 may be configured to connect to the one or more databases. The server 808 may be connected to at least one client device 804.

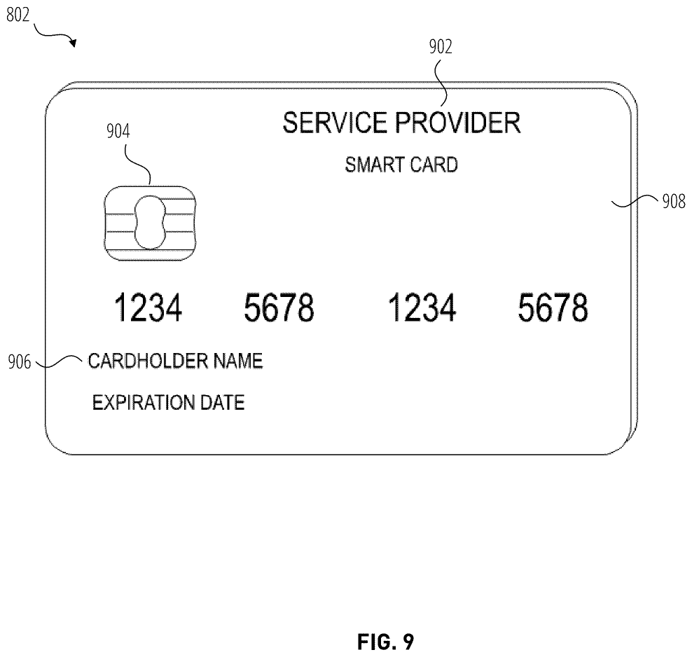

FIG. 9 illustrates an example configuration of a contactless card 802, which may include a contactless card or a payment card, such as a credit card, a debit card, or a gift card, issued by a service provider as displayed as service provider indicia 902 on the front or back of the contactless card 802. In some examples, the contactless card 802 is not related to a payment card and may include, without limitation, an identification card. In some examples, the contactless card 802 may include a dual interface contactless payment card, a rewards card, and so forth. The contactless card 802 may include a substrate 908, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 802 may have physical characteristics compliant with the ID-1 format of the ISO/IEC 7816 standard, and the contactless card 802 may otherwise be compliant with the ISO/IEC 14443 standard. However, it is to be understood that the contactless card 802 according to the present disclosure may have different characteristics, and the present disclosure does not require a contactless card 802 to be implemented in a payment card.

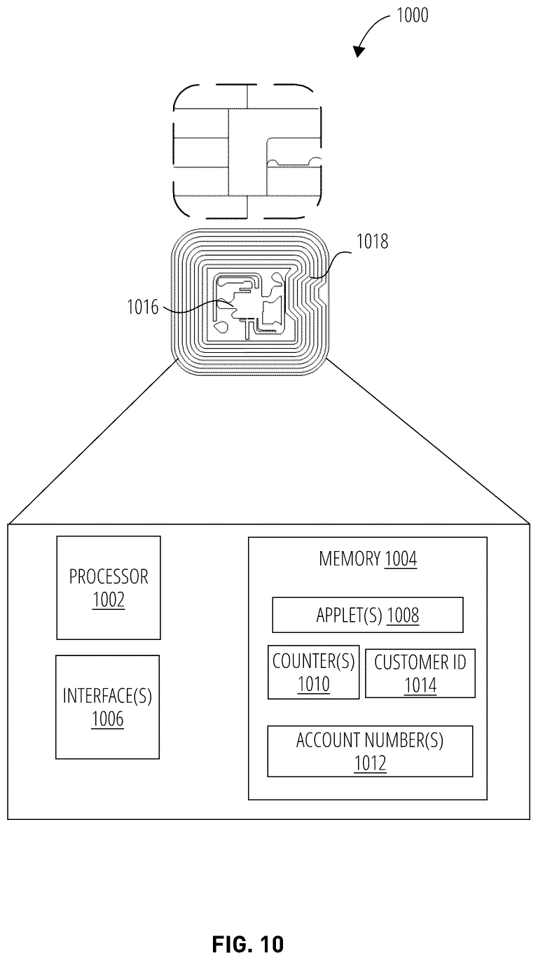

The contactless card 802 may also include identification information 906 displayed on the front and/or back of the card and a contact pad 904. The contact pad 904 may include one or more pads and be configured to establish contact with a client device, such as an ATM, a user device, a smartphone, a laptop, a desktop, or a tablet computer via transaction cards. The contact pad 904 may be designed in accordance with one or more standards, such as the ISO/IEC 7816 standard, and enable communication in accordance with the EMV protocol. The contactless card 802 may also include processing circuitry, antenna, and other components as will be further discussed in FIG. 10. These components may be located behind the contact pad 904 or elsewhere on the substrate 908, for example, within a different layer of the substrate 908, and may be electrically and physically coupled with the contact pad 904. The contactless card 802 may also include a magnetic strip or tape, which may be located on the back of the card (not shown in FIG. 9). The contactless card 802 may also include a Near-Field Communication (NFC) device coupled with an antenna capable of communicating via the NFC protocol. Embodiments are not limited in this manner.

As illustrated in FIG. 10, the contact pad 904 of FIG. 9 may include processing circuitry 1016 for storing, processing, and communicating information, including a processor 1002, a memory 1004, and one or more interface(s) 1006. It is to be understood that the processing circuitry 1016 may contain additional components, including processors, memories, error and parity/CRC checkers, data encoders, anticollision algorithms, controllers, command decoders, security primitives and tamperproofing hardware, as necessary, to perform the functions described herein.

The memory 1004 may be a read-only memory, write-once read-multiple memory, or read/write memory, e.g., RAM, ROM, and EEPROM, and the contactless card 802 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 1004 may be an encrypted memory utilizing an encryption algorithm executed by the processor 1002 to encrypt data.

The memory 1004 may be configured to store one or more applet(s) 1008, one or more counter(s) 1010, a customer identifier 1014, and one or more account number(s) 1012, which may be virtual account numbers. The one or more applet(s) 1008 may comprise one or more software applications configured to execute on one or more contactless cards, such as a Java® Card applet. However, it is to be understood that applet(s) 1008 are not limited to Java Card applets and, instead, may be any software application operable on contactless cards or other devices having limited memory. The one or more counter(s) 1010 may comprise a numeric counter sufficient to store an integer. The customer identifier 1014 may comprise a unique alphanumeric identifier assigned to a user of the contactless card 802, and the customer identifier 1014 may distinguish the user of the contactless card from other contactless card users. In some examples, the customer identifier 1014 may identify both a customer and an account assigned to that customer and may further identify the contactless card 802 associated with the customer's account. As stated, the account number(s) 1012 may include thousands of one-time use virtual account numbers associated with the contactless card 802. The applet(s) 1008 may be configured to manage the account number(s) 1012, for example, to select an account number(s) 1012, mark the selected account number(s) 1012 as used, and transmit the account number(s) 1012 to a mobile device or a client device 804 for autofilling by an autofilling service.

In some embodiments, the memory 1004 can include (e.g., have stored therein) the data from the fields illustrated in FIG. 4. The processor 1002 can then use the data from the fields to generate the message 400 as described above.

The processor 1002 and memory elements of the foregoing exemplary embodiments are described with reference to the contact pad 904, but the present disclosure is not limited thereto. It is to be understood that these elements may be implemented outside of the contact pad 904, entirely separate therefrom, or as further elements in addition to the processor 1002 and the memory 1004 elements located within the contact pad 904.

In some examples, the contactless card 802 may comprise one or more antenna(s) 1018. The one or more antenna(s) 1018 may be placed within the contactless card 802 and around the processing circuitry 1016 of the contact pad 904. For example, the one or more antenna(s) 1018 may be integral with the processing circuitry 1016, and the one or more antenna(s) 1018 may be used with an external booster coil. As another example, the one or more antenna(s) 1018 may be external to the contact pad 904 and the processing circuitry 1016.

In an embodiment, the coil of contactless card 802 may act as the secondary coil of an air core transformer. A terminal may communicate with the contactless card 802 by cutting power or amplitude modulation. The contactless card 802 may infer the data transmitted from the terminal using the gaps in the contactless card's power connection, which may be functionally maintained through one or more capacitors. The contactless card 802 may communicate back by switching a load on the contactless card's coil or load modulation. Load modulation may be detected in the terminal's coil through interference. More generally, using the antenna(s) 1018, the processor 1002, and/or the memory 1004, the contactless card 802 provides a communications interface to communicate via NFC, Bluetooth, and/or Wi-Fi communications.

As explained above, the contactless card 802 may be built on a software platform operable on smart cards or other devices having limited memory, such as JavaCard, and one or more or more applications or applets may be securely executed. The applet(s) 1008 may be added to the contactless card 802 to provide a one-time password (OTP) for multifactor authentication (MFA) in various mobile application-based use cases. The applet(s) 1008 may be configured to respond to one or more requests, such as near field data exchange requests, from a reader, such as a mobile NFC reader (e.g., of a mobile device or a point-of-sale terminal) and produce an NDEF message that comprises a cryptographically secure OTP encoded as an NDEF text tag.

One example of an NDEF OTP is an NDEF short-record layout (SR=1). In such an example, one or more applet(s) 1008 may be configured to encode the OTP as an NDEF type 4 well known type text tag. In some examples, NDEF messages may comprise one or more records. The applet(s) 1008 may be configured to add one or more static tag records in addition to the OTP record.

In some examples, the one or more applet(s) 1008 may be configured to emulate an RFID tag. The RFID tag may include one or more polymorphic tags. In some examples, each time the tag is read, different cryptographic data is presented that may indicate the authenticity of the contactless card. Based on the one or more applet(s) 1008, an NFC read of the tag may be processed, the data may be transmitted to a server, such as a server of a banking system, and the data may be validated at the server.

In some examples, the contactless card 802 and the server may include certain data such that the contactless card 802 card may be properly identified. The contactless card 802 may include one or more unique identifiers (not pictured). Each time a read operation takes place, the counter(s) 1010 may be configured to increment. In some examples, each time data from the contactless card 802 is read (e.g., by a mobile device), the counter(s) 1010 is transmitted to the server for validation and determination as to whether the counter(s) 1010 are equal (as part of the validation) to a counter of the server.

The one or more counter(s) 1010 may be configured to prevent a replay attack. For example, if a cryptogram has been obtained and replayed, that cryptogram is immediately rejected if the counter(s) 1010 has been read, used, or otherwise passed over. If the counter(s) 1010 has not been used, the counter(s) 1010 may be replayed. In some examples, the counter that is incremented on the card is different from the counter that is incremented for transactions. The contactless card 802 is unable to determine the application transaction counter(s) 1010 since there is no communication between the applet(s) 1008 on the contactless card 802.

In some examples, the counter(s) 1010 may get out of sync. In some examples, to account for accidental reads that initiate transactions, such as reading at an angle, the counter(s) 1010 may increment but the application does not process the counter(s) 1010. In some examples, when the client device 804 is woken up, NFC may be enabled and the client device 804 may be configured to read available tags, but no action is taken responsive to the reads.

To keep the counter(s) 1010 in sync, an application, such as a background application, may be executed that would be configured to detect when the client device 804 wakes up and synchronize with the server of a banking system, indicating that if a read occurred due to detection, then the counter(s) 1010 should be moved forward. In other examples, Hashed One Time Password may be utilized such that a window of mis-synchronization may be accepted. For example, if within a threshold of 10, the counter(s) 1010 may be configured to move forward. But if within a different threshold number, for example within 10 or 1000, a request for performing re-synchronization may be processed, which requests via one or more applications that the user tap, gesture, or otherwise indicate one or more times via the user's device. If the counter(s) 1010 increase in the appropriate sequence, then it possible to know that the user has done so.

The key diversification technique described herein with reference to the counter(s) 1010, the master key, and the diversified key is one example of encryption and/or decryption in a key diversification technique. This exemplary key diversification technique should not be considered limiting of the disclosure, as the disclosure is equally applicable to other types of key diversification techniques.

During the creation process of the contactless card 802, two cryptographic keys may be assigned uniquely per card. The cryptographic keys may comprise symmetric keys which may be used in both encryption and decryption of data. A Triple DES (3DES) algorithm may be used by EMV and implemented by hardware in the contactless card 802. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session). However, rather than using the master key, the unique card-derived keys and the counter may be used as diversification data. For example, each time the contactless card 802 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique and either assigned by personalization or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

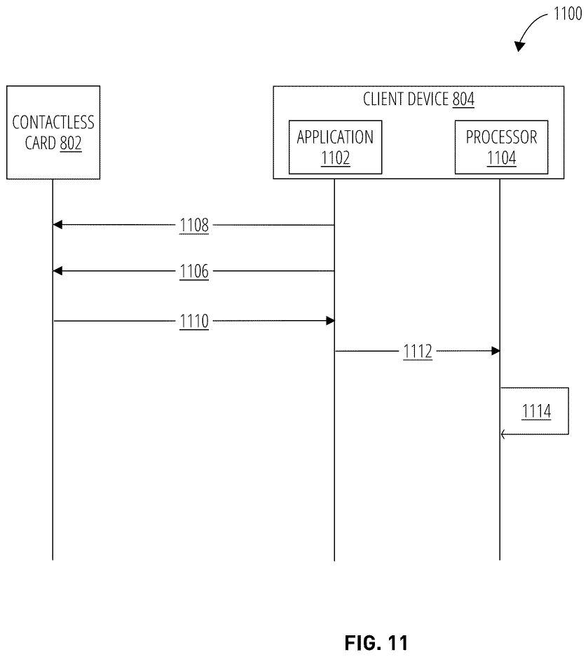

FIG. 11 is a timing diagram illustrating an example sequence flow 1100 for providing authenticated access according to one or more embodiments of the present disclosure. The sequence flow 1100 may include a contactless card 802 and a client device 804, which may include an application 1102 and a processor 1104.

At line 1108, the application 1102 communicates with the contactless card 802 (e.g., after being brought near the contactless card 802). Communication between the application 1102 and the contactless card 802 may involve the contactless card 8022 being sufficiently close to a card reader (not shown) of the client device 804 to enable NFC data transfer between the application 1102 and the contactless card 802.

At line 1106, after communication has been established between the client device 804 and the contactless card 802, the contactless card 802 generates a message authentication code (MAC) cryptogram. In some examples, this may occur when the contactless card 802 is read by the application 1102. In particular, this may occur upon a read, such as an NFC read, of a near field data exchange (NDEF) tag, which may be created in accordance with the NFC Data Exchange Format. For example, a reader application, such as the application 1102, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 802 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples, the MAC cryptogram may be included with a uniform resource indicator (e.g., as a formatted string). In some examples, the application 1102 may be configured to transmit a request to the contactless card 802, the request comprising an instruction to generate a MAC cryptogram.

At line 1110, the contactless card 802 sends the MAC cryptogram to the application 1102. In some examples, the transmission of the MAC cryptogram occurs via NFC. However, the present disclosure is not limited thereto. In other examples, this communication may occur via Bluetooth, Wi-Fi, or other means of wireless data communication. At line 1112, the application 1102 communicates the MAC cryptogram to the processor 1104.

At line 1114, the processor 1104 verifies the MAC cryptogram pursuant to an instruction from the application 1102. For example, the MAC cryptogram may be verified, as explained below. In some examples, verification of the MAC cryptogram may be performed by a device other than client device 804, such as a server of a banking system in data communication with the client device 804. For example, the processor 1104 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, for example, the Digital Signature Algorithm and the RSA algorithm or zero knowledge protocols, may be used to perform this verification.

FIGS. 1-11 are generally directed to systems and methods to authenticate a contactless card based on information on the contactless card. However, as previously discussed, some embodiments disclosed herein can include systems and methods for synchronizing a counter stored on the contactless card with a corresponding counter stored on a server and associated with the contactless card.

As disclosed herein, it is to be understood that the contactless card can be one that includes EMV technology and certificates and/or one that includes authentication technology and encrypted cryptograms as disclosed herein. Embodiments are not limited in this regard and can be used in connection with contactless cards as would be known and understood by one of ordinary skill in the art.

In accordance with disclosed embodiments, when a mobile device authenticates the contactless card in an offline transaction, for example, via offline data authentication, the mobile device can send a message to the server indicating that the mobile device successfully authenticated the contactless card with primary authentication data received from the contactless card. For example, the primary authentication data can include encrypted data, a public key, or a primary account number (PAN) of the contactless card.

Responsive to receiving the message from the mobile device, the server can authenticate the contactless card with secondary authentication data. For example, the secondary authentication data can include encrypted data, a phone number of the mobile device, or a geolocation of the mobile device. In particular, when the secondary authentication data includes the encrypted data, the server can decrypt the encrypted data to authenticate the contactless card with the secondary authentication information, for example decrypted using systems and methods described in connection with FIGS. 1-11. Additionally or alternatively, when the secondary authentication data includes the phone number of the mobile device, the server can compare the phone number of the mobile device with a phone number associated with the contactless card, and when there is a match therebetween, authenticate the contactless card with the secondary authentication information. Additionally or alternatively, when the secondary authentication data includes the geolocation of the mobile device, the server can compare a geolocation of the mobile device with approved geolocations associated with the contactless card, and when there is a match therebetween or the geolocation of the mobile device is within a predetermined distance from the approved geolocations, the server can authenticate the contactless card with the secondary authentication information.

In any embodiment, responsive to authenticating the contactless card with the secondary authentication data, the server can update, for example, by incrementing, a counter value associated with the contactless card and stored on the server to synchronize the counter value stored on the server with the counter stored on the contactless card. In some embodiments, the server can post a dummy transaction or a preauthorization in a record of transactions associated with the contactless card to update the counter value associated with the contactless card. Additionally or alternatively, in some embodiments, the server can instruct an internal or external processor to update the counter value associated with the contactless card in an internal or external database. Additionally or alternatively, in some embodiments, the server can record an updated version of the counter value associated with the contactless card in an authentication cryptogram as a last successful authentication attempt.

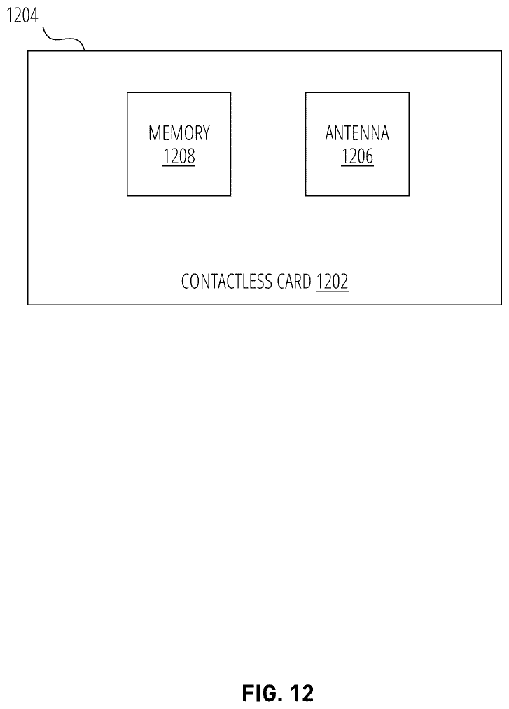

FIGS. 12-17 are generally directed to embodiments for synchronizing authentication attempts by synchronizing counters and provide additional details thereof. However, while embodiments disclosed herein are described in connection with the contactless card communicating with the mobile device, it is to be understood that embodiments disclosed are not so limited. Instead, embodiments disclosed herein can also include a user tapping or otherwise bringing the contactless card into a communication range of a short-range communication antenna of a desktop computer, a laptop computer, a tablet computer, or the like. As such, the contactless card can transmit to the desktop computer, the laptop computer, or the tablet computer and/or the desktop computer, the laptop computer, or the tablet computer can receive from the contactless card authentication data and messages as disclosed herein. In these embodiments, an operating system of the desktop computer, the laptop computer, or the tablet computer can include functions to support NFC between the contactless card and the desktop computer, the laptop computer, the tablet computer and/or browsers thereof via WebCT®.

FIG. 12 is a block diagram that illustrates an example of a contactless card 1202 in accordance with disclosed embodiments. It is to be understood that the contactless card 1202 can be the same as or similar to the contactless card 802 and that the contactless card 1202 can be associated with a customer account of a bank or a company that issued the contactless card 1202.

As seen, the contactless card 1202 can include a body 1204 and an antenna 1206 embedded in the body 1204. In some embodiments, the antenna 1206 can include a short-range communication antenna.

The contactless card 1202 can also include a memory 1208 embedded in the body 1204 and in communication with the antenna 1206. In some embodiments, the memory 1208 can include a read-only memory and/or a writeable memory. For example, in some embodiments, information, including a counter and/or an ATC, can be written to the memory during creation of the contactless card 1202. Additionally or alternatively, in some embodiments, information, including the counter and/or the ATC, can be written to or updated in the memory during use of the contactless card 1202.

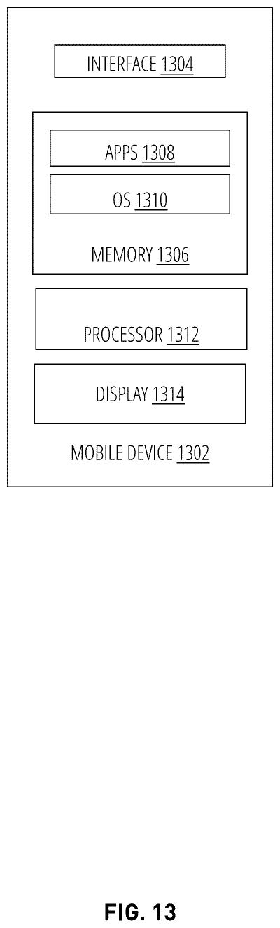

FIG. 13 is a block diagram that illustrates an example of a mobile device 1302 in accordance with disclosed embodiments. It is to be understood that the mobile device 1302 can be the same as or similar to the client device 614 and/or the client device 804.

As seen, the mobile device 1302 can include an interface 1304, a memory 1306, a processor 1312, and a display device 1314. The memory 1306 can be configured to store computer instructions configured to be executed by the processor 1312 to cause the processor 1312 to execute certain actions, and the computer instructions can be part of applications 1308 and/or an operating system 1310.

In some embodiments, the interface 1304 can include one or more antennas, such as a short-range communication antenna, one or more user interface devices, such as a key pad with hard or soft keys, and/or a camera, a microphone, a scanner, a card reader, or another device capable of reading or capturing images, information, or data within its range or field of view. Additionally or alternatively, the interface 1304 can include a Wi-Fi interface, a Bluetooth interface, an NFC interface, a serial bus interface, a universal serial bus (USB), and so forth.

In some embodiments, the memory 1306 can be any type of memory configured to store instructions to be processed by the processor 1312. Examples of the memory 1306 can include volatile or non-volatile memory, removable or non-removable memory, erasable or non-erasable memory, writeable or re-writeable memory, and so forth.

In some embodiments, the processor 1312 can be any type of processor, microprocessor, circuit, circuit element (e.g., transistor, resistor, capacitor, inductor, and so forth), integrated circuit, application specific integrated circuit (ASIC), programmable logic device (PLD), digital signal processor (DSP), field programmable gate array (FPGA), multi-core processor, and so forth.

In some embodiments, the display device 1314 can include a display screen or other output device for displaying data, information, and/or graphics to a user of the mobile device 1302.

The memory 1306 can include the applications 1308 and/or the operating system 1310. In this regard, the applications 1308 can include any type of application configured to operate on the mobile device 1302. For example, the applications 1308 can include mobile banking applications, mobile credit card applications, business applications, social networking applications, marketplace applications, classifieds applications, communication applications, business productivity applications (e.g., email, word processor, spreadsheet, etc.), storefront applications, money transfer applications, gaming applications, merchant applications, shopping mobile applications, and so forth.

The applications 1308 can be configured to operate within the operating system 1310. In some embodiments, the operating system 1310 can be an Android® operating system, Apple iOS® operating system, Windows Mobile Operating System®, and so forth. The operating system 1310 can be configured to provide services and instructions that execute and enable the applications 1308 to operate with hardware. For example, the operating system 1310 can be configured to operate with the hardware associated with the processor 1312 to process detections made by the interface 1304 and/or to transmit corresponding signals and data via the interface 1304. In some embodiments, the operating system 1310 can provide data to the applications 1308 processed by the operating system 1310. The applications 1308 can process such data, including performing authentications of the data, communicating the data to other devices or servers, and so forth. In some embodiments, at least a portion of the operating system 1310 can be configured to perform one or more authentication steps.

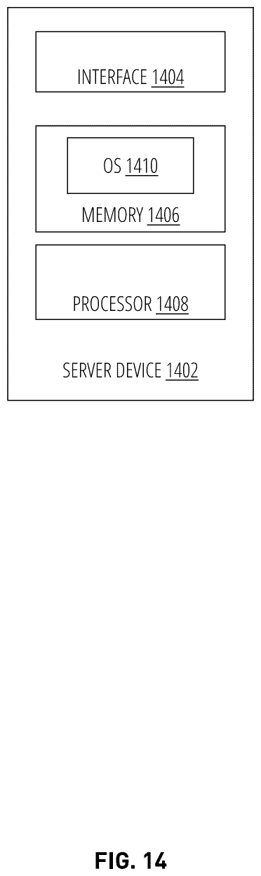

FIG. 14 is a block diagram that illustrates an example of a server device 1402 in accordance with disclosed embodiments. It is to be understood that the server device 1402 can be the same as or similar to the client node 602, the validation node 608, the distributed ledger node 610, and/or the server 808.

As seen, the server device 1402 can include an interface 1404, a memory 1406, and a processor 1408. The memory 1406 can be configured to store computer instructions configured to be executed by the processor 1408 to cause the processor 1408 to execute certain actions. The computer instructions can be part of an operating system 1410.

In some embodiments, the interface 1404 can be wired or wireless. For example, the interface 1404 can include a Wi-Fi_33 interface, a Bluetooth interface, an NFC interface, a serial bus interface, a universal serial bus (USB), and so forth.

In some embodiments, the memory 1406 can be any type of memory configured to store instructions to be processed by the processor 1408. Examples of the memory 1406 can include volatile or non-volatile memory, removable or non-removable memory, erasable or non-erasable memory, writeable or re-writeable memory, and so forth.

In some embodiments, the processor 1408 can be any type of processor, microprocessor, circuit, circuit element (e.g., transistor, resistor, capacitor, inductor, and so forth), integrated circuit, application specific integrated circuit (ASIC), programmable logic device (PLD), digital signal processor (DSP), field programmable gate array (FPGA), multi-core processor, and so forth.

As explained above, the memory 1406 can include the operating system 1410. In some embodiments, the operating system 1410 can include a Microsoft Windows server operating system, a Linux/Unix server operating system, a cloud server operating system, such as an Amazon AWS operating system, and so forth. The operating system 1410 can be configured to provide services and instructions that execute to operate with hardware. For example, the operating system 1410 can be configured to operate with the hardware associated with the processor 1408 to process signals and data received by the interface 1404, including performing authentication of such data and updating stored data, including counter values. In some embodiments, at least a portion of the operating system 1410 can be configured to perform one or more authentication steps.

FIG. 15 is a block diagram that illustrates an example of a system 1500 in accordance with disclosed embodiments. As seen, the system 1500 can include at least a mobile device 1502, a contactless card 1504, and a server device 1506 in communication with the mobile device 1502. It is to be understood that the mobile device 1502 can be the same as or similar to the mobile device 1302, the client device 614, and/or the client device 804. It is also to be understood that the server device 1506 can be the same as or similar to the server device 1402, the client node 602, the validation node 608, the distributed ledger node 610, and/or the server 808 and that the contactless card 1504 can be the same as or similar to the contactless card 1202 and/or the contactless card 802.

In some embodiments, the contactless card 1504 can be used in connection with an offline transaction, for example, to confirm an identity of an authorized cardholder. Such offline transactions can include, for example, static data authentication (SDA), dynamic data authentication (DDA), and/or combined dynamic data authentication (DDA). In particular, in some embodiments, a user can tap or otherwise bring the contactless card 1504 within a communication range of a short-range communication antenna of the mobile device 1502, and the contactless card 1504 can transmit data to the mobile device 1502 and/or the mobile device 1502 can read the data from the contactless card 1504. In some embodiments, such data can be retrieved from a memory embedded in a body of the contactless card 1504 and transmitted via an antenna embedded in the body of the contactless card 1504.

Each such interaction with the contactless card 1504 activates an applet on the contactless card 1504, thereby incrementing a counter and/or an ATC, stored in a memory of the contactless card 1504. However, when the mobile device 1502 communicates with the contactless card 1504 during the offline transaction, a corresponding counter stored on the server device 1506 fails to increment in a corresponding manner because offline transactions need not communicate with the server device 1506 to confirm the identity of the authorized cardholder. As such, the counter stored on the contactless card 1504 will be out of sync with the corresponding counter stored on the server device 1506, which may result in the contactless card 1504 being declined and/or deactivated when used in connection with a future online transaction that communicates with the server device 1506 to authenticate the contactless card 1504.

Embodiments disclosed herein can synchronize the counter stored on the contactless card 1504 with the corresponding counter stored on the server device 1506 as follows. When the mobile device 1502 authenticates the contactless card 1504 in the offline transaction, for example, via offline data authentication, the mobile device 1502 can send a message to the server device 1506 indicating that the mobile device 1502 successfully authenticated the contactless card 1504 with primary authentication data received from the contactless card 1504. For example, the primary authentication data can include encrypted data, a public key, or a primary account number (PAN) of the contactless card 1504. Such encrypted data can include, for example, a cryptogram encrypted using systems and methods described in connection with FIGS. 1-11.

Responsive to receiving the message from the mobile device 1502, the server device 1506 can authenticate the contactless card 1504 with secondary authentication data, and in some embodiments this second authentication can be invisible to the user, not requiring additional user input or interaction to complete. In some embodiments, the secondary authentication data can include encrypted data, a phone number of the mobile device 1502, or a geolocation of the mobile device 1502. When the secondary authentication data includes the encrypted data, the mobile device 1502 can transmit the encrypted data to the server device 1506, and the server device 1506 can decrypt the encrypted data to authenticate the contactless card 1504, for example, decrypted using systems and methods described herein in connection with FIGS. 1-11. Additionally or alternatively, when the secondary authentication data includes the phone number of the mobile device, the server device 1506 can compare the phone number of the mobile device 1502 with a phone number associated with the contactless card 1504 and stored on the server device 1506, and when there is a match therebetween, authenticate the contactless card 1504 with the secondary authentication information. Additionally or alternatively, when the secondary authentication data includes the geolocation of the mobile device, the server device 1506 can compare a geolocation of the mobile device 1502 with approved geolocations associated with the contactless card 1504 and stored on the server device 1506, and when there is a match therebetween or the geolocation of the mobile device 1502 is within a predetermined distance from the approved geolocations, the server device 1506 can authenticate the contactless card 1504 with the secondary authentication information.

As explained above, the contactless card 1504 can be associated with a customer account. As such, in some embodiments, the server device 1506 can identify the customer account to authenticate the contactless card 1504. In particular, in some embodiments, the server device 1506 can decrypt protected data in the encrypted data and compare the protected data to record data associated with the customer account and stored on the server device 1506. When the protected data matches the record data, the server device 1506 can authenticate the contactless card 1504. Additionally or alternatively, in some embodiments, the server device 1506 can receive, retrieve, or otherwise obtain the secondary authentication data, including the phone number and/or the geolocation of the mobile device, from the mobile device 1502 and compare the secondary authentication data received with corresponding data associated with the customer account and stored on the server device 1506.

It is to be understood that, in some embodiments, the contactless card 1504 will not be authenticated unless registered with the server device 1506 so as to be associated with the customer account. In this regard, without such registration and association, the server device 1506 may not be capable of decrypting the encrypted data and/or the protected data in the encrypted data, for example, due to lacking required keys and the like, or may not be capable of comparing and/or matching the secondary authentication data received from the mobile device 1502 with any corresponding data stored on the server device 1506. Additionally or alternatively, without such registration and association, the server device 1506 may be able to decrypt the encrypted data and/or the protected data in the encrypted data, but may not be able to match the protected data to any record data stored for registered cards. In this regard, the contactless card 1504 can be associated with the customer account in a database or a data store maintained by the server device 1506. As such, the mobile device 1502 can provide the data received from the contactless card 1504 as well identifying data, such as an account number or a user ID, to the server device 1506, and the server device 1506 can utilize such received information to identify the customer account and verify that the customer account is associated with the contactless card 1504.

Responsive to authenticating the contactless card 1504 with the secondary authentication data, the server device 1506 can update, for example, by incrementing, a counter value associated with the contactless card 1504 and stored on the server device 1506 to synchronize the counter value stored on the server device 1506 with the counter stored on the contactless card 1504. In some embodiments, the server device 1506 can post a dummy transaction or a preauthorization in a record of transactions associated with the contactless card 1504 and stored on the server device 1506 to update the counter value associated with the contactless card 1504. In embodiments, the dummy transaction can be a zero-dollar ($0) transaction, a null transaction, a nominal transaction, or any other defined transaction recognizable by the service device 1506. Additionally or alternatively, in some embodiments, the server device 1506 can instruct an internal or external processor to update the counter value associated with the contactless card 1504 in an internal or external database. Additionally or alternatively, in some embodiments, the server device 1506 can record an updated version of the counter value associated with the contactless card 1504 in an authentication cryptogram associated with the contactless card 1504 and stored on the server device 1506 so that the updated version of the counter value is identified as a last successful authentication attempt.

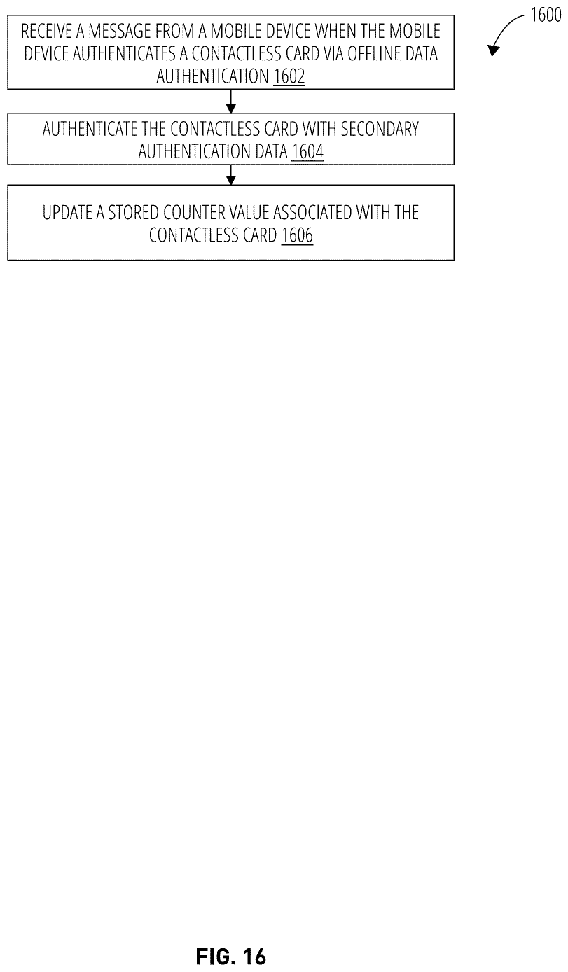

FIG. 16 is a flow chart that illustrates an example of a method 1600 in accordance with disclosed embodiments. In some embodiments, a server device, such as the server device 1506, the client node 602, the validation node 608, the distributed ledger node 610, and/or the server 808 can execute some or all of the method 1600.

As seen, the method 1600 can include receiving a message from a mobile device when the mobile device authenticates a contactless card via offline data authentication as in 1602. In some embodiments, the message can indicate that the mobile device successfully authenticated the contactless card with primary authentication data received from the contactless card, for example, via a short-range communication antenna of the mobile device. In particular, a user can tap or otherwise bring the contactless card within a communication range of the mobile device, and the mobile device can read the primary authentication data from the contactless card. In some embodiments, the primary authentication data can include encrypted data, a public key, or a primary account number (PAN) of the contactless card, and in some embodiments, such encrypted data can include, for example, a cryptogram, encrypted using systems and methods described in connection with FIGS. 1-11.

Responsive to receiving the message from the mobile device, the method 1600 can include authenticating the contactless card with secondary authentication data as in 1604. For example, the secondary authentication data can include encrypted data, a phone number of the mobile device, or a geolocation of the mobile device. When the secondary authentication data includes the encrypted data, the mobile device can transmit the encrypted data to the server device, and the server device can decrypt the encrypted data to authenticate the contactless card, for example, decrypted using systems and methods described herein in connection with FIGS. 1-11. Additionally or alternatively, when the secondary authentication data includes the phone number of the mobile device, the server device can compare the phone number of the mobile device with a phone number associated with the contactless card and stored on the server device, and when there is a match therebetween, authenticate the contactless card with the secondary authentication information. Additionally or alternatively, when the secondary authentication data includes the geolocation of the mobile device, the server device can compare a geolocation of the mobile device with approved geolocations associated with the contactless card and stored on the server device, and when there is a match therebetween or the geolocation of the mobile device is within a predetermined distance from the approved geolocations, the server device can authenticate the contactless card with the secondary authentication information.

The contactless card can be associated with a customer account. As such, in some embodiments, the customer account can be identified to authenticate the contactless card. In particular, in some embodiments, protected data in the encrypted data can be decrypted and compared to record data associated with the customer account and/or the secondary authentication data received can be compared to corresponding data associated with the customer account. When the protected data matches the record data or the received data matches the stored data, the contactless card can be authenticated.

Finally, when the contactless card has been successfully authenticated with the secondary authentication data, the method 1600 can include updating a stored counter value associated with the contactless card as in 1606. For example, in some embodiments, the method 1600 can include incrementing a counter value associated with the contactless card and stored on the server device to synchronize the counter value stored on the server device with a counter stored on the contactless card. Additionally or alternatively, in some embodiments, the method 1600 can include posting a dummy transaction or a preauthorization in a record of transactions associated with the contactless card and stored on the server device to update the counter value associated with the contactless card. Additionally or alternatively, in some embodiments, the method 1600 can include instructing an internal or external processor to update the counter value associated with the contactless card in an internal or external database. Additionally or alternatively, in some embodiments, the method 1600 can include recording an updated version of the counter value associated with the contactless card in an authentication cryptogram associated with the contactless card and stored on the server device so that the updated version of the counter value is identified as a last successful authentication attempt.

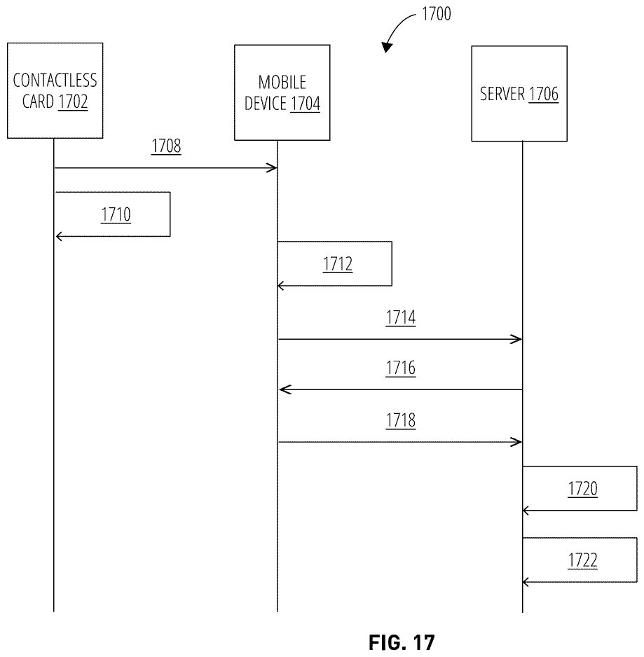

FIG. 17 illustrates an example of a sequence flow 1700 in accordance with disclosed embodiments. A contactless card 1702 can be the same as or similar to the contactless card 1504, the contactless card 1202, and/or the contactless card 802. Furthermore, a mobile device 1704 can be the same as or similar to the mobile device 1502, the mobile device 1302, the client device 614, and/or the client device 804. Still further, a server 1706 can be the same as or similar to the server device 1506, the server device 1402, the client node 602, the validation node 608, the distributed ledger node 610, and/or the server 808. In some embodiments, the mobile device 1704 and/or the server 1706 can perform decryption and/or authentication.

The contactless card 1702 can be tapped on or brought within a communication range of the mobile device 1704 and can exchange information with the mobile device 1704 to confirm an identity of an authorized cardholder. Line 1708 can represent such communication between the contactless card 1702 and the mobile device 1704 and can include primary authentication data and/or secondary authentication data stored on the contactless card 1702 and provided to the mobile device 1704. In some embodiments, the primary authentication data and/or the secondary authentication data can be retrieved from a memory embedded in a body of the contactless card 1702 and transmitted via an antenna embedded in the body of the contactless card 1702.

The mobile device 1704 can use the primary authentication data to authenticate the contactless card 1702 at 1712, and this authentication can be understood as an offline transaction.

In some embodiments, communications between the contactless card 1702 and the mobile device 1704 can include NFC in accordance with one or more NFC protocols. However, embodiments disclosed herein are not so limited and can include other wireless technologies in addition to or as an alternative to NFC, such as other short-range communication protocols.

Each interaction with the contactless card 1702 can increment at 1710 a counter and/or an ATC stored in a memory of the contactless card 1702. However, when the contactless card 1702 communicates with the mobile device 1704 in support of the offline transaction at 1712, a corresponding counter stored on the server 1706 fails to increment in a corresponding manner because offline transactions need not communicate with the server 1706 to confirm the identity of the authorized cardholder. As such, the counter stored on the contactless card 1702 will be out of sync with the corresponding counter stored on the server 1706.

In accordance with disclosed embodiments, when the mobile device 1704 authenticates the contactless card 1702 in the offline transaction at 1712, the mobile device 1704 can send a message to the server 1706 indicating that the mobile device 1704 successfully authenticated the contactless card 1702 with the primary authentication data received from the contactless card 1702. Line 1714 can represent such communication between the mobile device 1704 and the server 1706.

Responsive to receiving the message from the mobile device 1704 at 1714, the server 1710 can optionally solicit at 1716 and receive at 1718 the secondary authentication data from the mobile device 1704. However, in some embodiments, the secondary authentication data can be included in the message the server 1706 received at 1712 so, in these embodiments, no further solicitation of the same may be necessary. In some embodiments, the secondary authentication data can include data that the mobile device 1704 received from the contactless card 1702 and/or data that the mobile device 1704 retrieved from local memory or from signal data received from other sources, such as geolocation devices.

It is to be understood that the server 1706 can process any data, information, and/or requests received from the mobile device 1704 either partially or fully. It is also to be understood that the mobile device 1704 can communicate with the server 1706 via one or more wireless and/or wired connections. For example, in some embodiments, the mobile device 1704 can transmit any data, information, or requests to one or more application program interfaces hosted by the server 1706. Additionally or alternatively, in some embodiments, the mobile device 1704 can transmit any data, information, or requests to one or more application program interfaces hosted by a third party, such as a cloud-computing provider.

Once the server 1706 receives the secondary authentication data from the mobile device 1704, the server 1706 can authenticate at 1720 the contactless card 1702 with the secondary authentication data. As explained above, the contactless card 1702 can be associated with a customer account. As such, in some embodiments, the server 1706 can use some data received from the mobile device 1704 to identify the customer account. When the secondary authentication data includes encrypted data, the server 1706 can decrypt the encrypted data to authenticate the contactless card 1702, for example, decrypted using systems and methods described herein in connection with FIGS. 1-11, and compare the protected data to record data associated with the customer account and stored on the server 1706. When the protected data matches the record data, the server 1706 can authenticate the contactless card 1702. Additionally or alternatively, when the encrypted data includes a phone number of the mobile device 1704, the server 1706 can compare the phone number of the mobile device 1704 with a phone number associated with the customer account and stored on the server 1706, and when there is a match therebetween, authenticate the contactless card 1702 with the secondary authentication information. Additionally or alternatively, when the secondary authentication information includes a geolocation of the mobile device, the server 1706 can compare the geolocation of the mobile device 1704 with approved geolocations associated with the customer account and stored on the server 1706, and when there is a match therebetween or the geolocation of the mobile device 1704 is within a predetermined distance from the approved geolocations, the server 1706 can authenticate the contactless card 1702 with the secondary authentication information.

In any embodiment, responsive to authenticating the contactless card 1702 with the secondary authentication data at 1720, the server 1706 can update at 1722 a counter value associated with the contactless card 1702 and stored on the server 1706 to synchronize the counter value stored on the server 1706 with the counter stored on the contactless card 1702. In some embodiments, the server 1706 can increment the counter value associated with the contactless card 1702 and stored on the server 1706 to update the update the counter value associated with the contactless card 1702. Additionally or alternatively, in some embodiments, the server 1706 can post a dummy transaction or a preauthorization in a record of transactions associated with the contactless card 1702 and stored on the server 1706 to update the counter value associated with the contactless card 1504. Additionally or alternatively, in some embodiments, the server 1706 can instruct an internal or external processor to update the counter value associated with the contactless card 1702 in an internal or external database. Additionally or alternatively, in some embodiments, the server 1706 can record an updated version of the counter value associated with the contactless card 1702 in an authentication cryptogram associated with the contactless card 1702 and stored on the server device 1506 so that the updated version of the counter value is identified as a last successful authentication attempt.

What is claimed is:

1. A method comprising:
receiving a message from a mobile device when the mobile device authenticates a contactless card via offline data authentication, the message indicating that the mobile device successfully authenticated the contactless card with primary authentication data received from the contactless card;
authenticating the contactless card with secondary authentication data; and
posting a dummy transaction or a preauthorization in a record of transactions associated with the contactless card to update a stored counter value associated with the contactless card,
wherein interaction between the contactless card and the mobile device during the offline data authentication increments a counter stored on the contactless card, and
wherein updating the stored counter value associated with the contactless card synchronizes the stored counter value with the counter stored on the contactless card.

2. The method of claim 1 wherein the primary authentication data includes encrypted data, a public key, or a primary account number of the contactless card.

3. The method of claim 1 wherein the secondary authentication data includes encrypted data, a phone number of the mobile device, or a geolocation of the mobile device.

4. The method of claim 3 further comprising:
comparing the phone number of the mobile device with a phone number associated with the contactless card; and
authenticating the contactless card with the secondary authentication information when the phone number of the mobile device matches the phone number of the contactless card.

5. The method of claim 3 further comprising:
comparing the geolocation of the mobile device with approved geolocations associated with the contactless card; and
authenticating the contactless card with the secondary authentication information when the geolocation of the mobile device matches or is within a predetermined distance from the approved geolocations associated with the contactless card.

6. The method of claim 1 further comprising:
instructing a processor to update the stored counter value associated with the contactless card in a database.

7. The method of claim 1 further comprising:
recording the stored counter value as updated in an authentication cryptogram as a last successful authentication attempt.

8. A non-transitory computer-readable medium comprising instructions that, when executed by a processor, cause the processor to:
receive a message from a mobile device when the mobile device authenticates a contactless card via offline data authentication, the message indicating that the mobile device successfully authenticated the contactless card with primary authentication data received from the contactless card;
authenticate the contactless card with secondary authentication data; and
update a stored counter value associated with the contactless card,
wherein interaction between the contactless card and the mobile device during the offline data authentication increments a counter stored on the contactless card, and
wherein updating the stored counter value associated with the contactless card synchronizes the stored counter value with the counter stored on the contactless card.

9. The non-transitory computer-readable medium of claim 8 wherein the primary authentication data includes encrypted data, a public key, or a primary account number of the contactless card.

10. The non-transitory computer-readable medium of claim 8 wherein the secondary authentication data includes encrypted data, a phone number of the mobile device, or a geolocation of the mobile device.

11. The non-transitory computer-readable medium of claim 8 wherein the instructions further cause the processor to post a dummy transaction or a preauthorization in a record of transactions associated with the contactless card to update the stored counter value associated with the contactless card.

12. The non-transitory computer-readable medium of claim 8 wherein the instructions further cause the processor to update the stored counter value associated with the contactless card in a database.

13. The non-transitory computer-readable medium of claim 8 wherein the instructions further cause the processor to record the stored counter value as updated in an authentication cryptogram as a last successful authentication attempt.

14. A server device comprising:
a processor; and
a memory storing instructions that, when executed by the processor, cause the processor to:
receive a message from a mobile device when the mobile device authenticates a contactless card via offline data authentication, the message indicating that the mobile device successfully authenticated the contactless card with primary authentication data received from the contactless card;
authenticate the contactless card with secondary authentication data; and
update a stored counter value associated with the contactless card.

15. The server device of claim 14 wherein the primary authentication data includes encrypted data, a public key, or a primary account number of the contactless card.

16. The server device of claim 14 wherein the secondary authentication data includes encrypted data, a phone number of the mobile device, or a geolocation of the mobile device.

17. The server device of claim 14 wherein interaction between the contactless card and the mobile device during the offline data authentication increments a counter stored on the contactless card, and wherein updating the stored counter value associated with the contactless card synchronizes the stored counter value with the counter stored on the contactless card.

18. The server device of claim 14 wherein the instructions further cause the processor to post a dummy transaction or a preauthorization in a record of transactions associated with the contactless card to update the stored counter value associated with the contactless card.

19. The server device of claim 14 wherein the instructions further cause the processor to update the stored counter value associated with the contactless card in a database.

20. The server device of claim 14 wherein the instructions further cause the processor to record the stored counter value as updated in an authentication cryptogram as a last successful authentication attempt.
